(19) United States
(12) Patent Application Publication
(10) Pub. No.: US 2025/0062044 A1
(43) Pub. Date: Feb. 20, 2025

(54) NUCLEAR MATERIAL AND METHODS

(71) Applicant: Fusion Energy Solutions, Inc., Tempe, AZ (US)

(72) Inventors: Ian Shawn Horvath, Phoenix, AZ (US); Dr. Yiyang Li, Tempe, AZ (US); Dr. Charles Edwin Runyan, Tempe, AZ (US)

(73) Assignee: Fusion Energy Solutions, Inc., Tempe, AZ (US)

(21) Appl. No.: 18/821,291

(22) Filed: Aug. 30, 2024

Related U.S. Application Data
(63) Continuation of application No. 17/099,198, filed on Nov. 16, 2020, now abandoned.
(60) Provisional application No. 62/937,004, filed on Nov. 18, 2019.
(60) Provisional application No. 62/936,701, filed on Nov. 18, 2019.
(60) Provisional application No. 62/936,882, filed on Nov. 18, 2019.
(60) Provisional application No. 62/936,234, filed on Nov. 15, 2019.
(60) Provisional application No. 62/936,318, filed on Nov. 15, 2019.
(60) Provisional application No. 62/935,988, filed on Nov. 15, 2019.

(51) Int. Cl. G21C 7/24; G21C 3/04

(52) U.S. Cl. CPC G21C 7/24; G21C 3/045

(57) ABSTRACT

Methods of providing load following capability to commercial nuclear reactors. Materials that thwart nuclear reactor hotspots and transients by absorbing excess neutrons such as hard or high energy neutrons. Nuclear fuel additives to stabilize nuclear reactor transients. Materials that interact more strongly with high energy neutrons than they do with now energy or thermal neutrons.

### CROSS-REFERENCE TO RELATED APPLICATIONS

This application is related to and claims priority to U.S. Provisional Patent Application Nos., all of which are incorporated by reference.

| | |
|---|---|
| 62/935,988 | 15-NOV-2019 |
| 62/936,234 | 15-NOV-2019 |
| 62/936,318 | 15-NOV-2019 |
| 62/937,004 | 18-NOV-2019 |
| 62/936,701 | 18-NOV-2019 |
| 62/936,882 | 18-NOV-2019 |

### BACKGROUND

When operating conventional nuclear reactors, sometimes random transients or hot spots occur throughout the reactor fuel. Left unchecked, the number of hot spots and transients can exponentially increase. This increase can lead to an exponential increase in reactor power, quickly exceeding the reactor's design basis in regions near the hotspot or transient. The most severe power increases can meltdown of the fuel, the fuel-rod cladding, and the containment. Even much milder events can permanently and significantly damage fuel pellets. The unusual, transient and hotspot power increase damages fuel pellets. Commercial reactors produce xenon gas. The fuel pellets withstand and accommodate the steady-state amounts of xenon. But transient and hotspot power increases produce an unusual amount of xenon, which can fracture the fuel pellet as xenon overwhelms the pellet's xenon capacity.

The power spike can also thermally stress the fuel pellet leading to it cracking and fissuring, which also mechanically shortens the fuel pellet's life.

Transient numbers increase when the reactor power level increases or decreases—when the power level is changed. But the ability to change power output more safely would allow utilities to implement some degree of load following in the reactor. “Load following” is the ability to have power output from a power plant follow the grid's instantaneous power demands to one extent or another. Alternatively, “load following” is the ability to have a plant's output better follow the grids instantaneous demands.

Load following is a tool that nuclear-power-plant operators very much want. But implementing it using current technology unacceptably risks generating uncontrollable transients or hot spots as the operator varies reactor output. Current technology can't provide this tool; it remains out of reach.

Current control of transient or hotspot activity includes constructing the pellet to have a strong negative temperature coefficient of reactivity. A negative temperature coefficient of thermal reactivity means that the material in the pellet becomes less reactive as the pellet's temperature rises. This negative reactivity helps decrease the fission rate, but it happens on a thermal time scale. What is needed is a technique to combat the reaction rate increase caused by transients and hot spots on a time scale aligned with the increasing reaction rate.

### BRIEF DESCRIPTION OF THE DRAWINGS

FIG. 1A shows a schematic view of a nuclear fuel pellet.

FIG. 1B is a schematic view of another embodiment of a nuclear fuel pellet.

FIG. 1C is a schematic view of the nuclear fuel pellet of yet another embodiment.

FIG. 2 is a schematic view of the nuclear fuel rod.

FIG. 3 shows a schematic view of a pellet or plate of nuclear adjuvant material (210,100).

### DETAILED DESCRIPTION

The problem is too many neutrons. But the reactor needs neutrons, specifically thermal neutrons, to operate. One neutron for each fission event is needed to sustain the reaction. If this neutron flux increases, the reactor power increases, which generates even more prompt neutrons that cause even more fuel to fission and on and on. For this discussion, “prompt neutrons” are neutrons recently generated from a fission event. Prompt neutrons have much higher energies than energies useful for safely operating the reactor. And since they are excess neutrons, the reactor doesn't need them to function. But neutrons at these energies are vital because they moderate into thermal neutrons.

At its most basic level, the new fuel is a nuclear adjuvant material added to conventional nuclear fuel.

“Improve the reactor” means any one or any combination of factors that extend fuel life, lower the mechanical failure rate of the pellet, decrease the number of transients, decrease the density of transients, decrease the average number of hot spots, decrease the density of hot spots, prevent the increase in the average temperature of hot spots, decrease the average lifespan of hot spots, decrease the average lifespan of transients, decrease the propagation rate of transients, or decrease the propagation rate of hot spots.

Faster and more precise control over transients and transient dampening would give operators better load-following capability.

“Fissile material” is any material capable of undergoing fission to produce useful heat energy. “Fissile material” is a material commonly used as a fuel component in commercial nuclear power plants and that undergoes a fission reaction to produce heat. some embodiments, “useful heat energy” is over 25 kW.

“Transuranic atoms” are atoms produced in commercial nuclear fuel by reactor operation. Most of these come from neutrons colliding with uranium 238, which frequently captures the neutron and yields an element with a higher atomic number or atomic mass. In some embodiments, the term “transuranics” represents neptunium, plutonium, americium, curium, berkelium, and californium. In some embodiments, the term “transuranics” represents Np^{237, 238, and 239}; Py^{238, 239,240,241,242, and 243}; Am^{241,242,243, and 242}.

“Nuclear adjuvant material” is any material that undergoes a nuclear reaction with a high-energy neutron or other radiation generated in nuclear reactor transients and yields products, none of which are neutrons. A nuclear adjuvant absorbs hardened neutrons during transient events in a commercial nuclear power plant or absorbs other types of radiation that result in dampening the transient.

In some versions, “nuclear adjuvant material” is any material that exhibits a nuclear adjuvant effect which means the material undergoes a nuclear reaction with a high-energy neutron or other radiation generated in nuclear reactor transients and yields products in which less than 50%, 40%, 30%, 20%, 10%, 5%, 1%, 2×10⁻²%, 4×10⁻³%, 8×10⁻⁴%, 1.6×10⁻⁴%, 3.2×10⁻⁵%, 6.4×10⁻⁶%, 1.28×10⁻⁶%, 2.56×10⁻⁷%, 5.12×10⁻⁸%, 1.02×10⁻⁸%, 2.05×10⁻⁹%, or 4.1×10⁻¹⁰% are neutrons. A nuclear adjuvant absorbs hardened neutrons during transient events in a commercial nuclear power plant or absorbs other types of radiation that result in dampening the transient.

Another characteristic of the nuclear adjuvant is that it undergoes a nuclear reaction with the incoming neutron and converts it into some other atomic particle. For instance, the nuclear reaction could yield a proton, Alpha particle, or gamma-ray. This absorption thwarts transient event propagation by removing high-energy, transient neutrons from the system, which normalizes the number of new fission events. So, enough high-energy neutrons must be absorbed to dampen the transient. Conversely, the material shouldn't absorb too many neutrons, or the steady-state operation of the reactor would be heavily affected.

The material comprises atoms or compounds containing atoms that exhibit the desired nuclear properties. In some embodiments, these atoms are chosen to provide neutron-energy-versus-neutron-absorption curves with as little a cross-section as possible in the low energy range. The cross-section's high-energy behavior yields a change in the cross-section that trims off enough high-energy neutrons to dampen the transient while maintaining the reactor's steady-state operation.

In some embodiments, the nuclear adjuvant material trims between 0.00001-110% or 0.00001-0.0001 of the excess high-energy neutrons. The material in various embodiments comprises atoms with 1-10, 1-5, 2-5, or 3-5 different atomic numbers or different atomic masses.

In nuclear and particle physics, the concept of a neutron cross section is used to express the likelihood of interaction between an incident neutron and a target nucleus. In conjunction with the neutron flux, it enables the calculation of the reaction rate. The standard unit for measuring the cross section is the barn, which is equal to 10-28 m2 or 10-24 cm2. The larger the neutron cross section, the more likely a neutron will react with the nucleus.

In some embodiments, suitable components include all isotopes or elements. More practical examples include mixtures selected from elements and isotopes that are substantially chemically and thermally stable inside the reactor. In some embodiments, the mixture's components are selected from materials easily handled in the fuel rod or fuel-production process. For this disclosure, easily handleable means that the cost involved and safely manipulating the materials does not exceed the economic benefit associated with using the material as a component of nuclear fuel rods. Other suitable but not mandatory characteristics include materials with low or very low neutron cross-sections in low energy ranges. Endothermic nuclear reactions are also a practical target because if the neutron energy is lower than the energy absorbed by the endothermic nuclear reaction, the relevant cross-section is theoretically zero. Having materials with low or zero neutron absorption in lower neutron energy ranges minimizes the adjuvant material's interaction with the thermal neutrons present in the reactor and necessary for the fission reaction to continue as normal.

In other embodiments, high-energy neutron absorption divided by low-energy neutron absorption is high. Low energy-range neutrons are neutrons with energies between 0-1 MeV, 0-500 KeV, or 0-300 KeV. High-energy neutrons are neutrons in energy ranges greater than 800 KeV, greater than 900 KeV, greater than 1 MeV, or greater than 1.2 MeV. In some embodiments, high-energy neutrons are neutrons with energies of 3 MeV up to 20 MeV.

Useful components of a nuclear adjuvant material include compounds or mixtures comprising two or more (alternatively, three, four, five, or six, or more) of Ba, As, Br, Ce, Cl, Co, F, Ga, Ge, K, La, Mo, Nd, Os, Pr, S, Sr, Ti, Tl, V, and Zr. Useful components of a nuclear adjuvant material include compounds or mixtures comprising two or more (alternatively, three, four, five, or six, or more) of As, Ce, Co, Ga, Ge, La, Mo, Nd, Os, Pr, Ti, V, and Zr. The compounds and mixtures can be created by combining the listed elements or combining other elements with the listed elements.

Useful adjuvant material includes mixtures or compounds comprising any one or any combination of F, K, Ti; of Ba, As, Br; of Ca, Cl, Co; of F, Ga, Ge; of K, La, Mo; of Nd, Os, Pr; of S, Sr, Tl; of Tl, V, Zr; of Ba, Br, Cl; of As, Ce, Cl; of Br, Cl, F; of Ce, Co, Ga; of Cl, F, Ge; of Co, Ga, K; of F, Ge, K; of Ga, K, Mo; of Ge La, Nd; of K, Mo, Os; of La, Nd, Pr; of Mo, Os, Pr; of Nd, Pr, St; of Os, S, Ti; of Tl, Zr, Ba; of F, Tl, V; of K, Ba, Br; and of Zr, Sr, Os—elements or compounds.

Useful components of a nuclear adjuvant material include compounds or mixtures consisting essentially of two or more (alternatively, three, four, five, or six, or more) of Ba, As, Br, Ce, Cl, Co, F, Ga, Ge, K, La, Mo, Nd, Os, Pr, S, Sr, Ti, Tl, V, and Zr. Useful components of a nuclear adjuvant material include compounds or mixtures consisting essentially of two or more (alternatively, three, four, five, or six, or more) of As, Ce, Co, Ga, Ge, La, Mo, Nd, Os, Pr, Ti, V, and Zr. The compounds and mixtures can combine the listed elements or combine other elements with the listed elements.

Useful adjuvant material includes mixtures or compounds consisting essentially of F, K, Ti; of Ba, As, Br; of Ca, Cl, Co; of F, Ga, Ge; of K, La, Mo; of Nd, Os, Pr; of S, Sr, Ti; of Tl, V, Zr; of Ba, Br, Cl; of As, Ce, Cl; of Br, Cl, F; of Ce, Co, Ga; of Cl, F, Ge; of Co, Ga, K; of F, Ge, K; of Ga, K, Mo; of Ge La, Nd; of K, Mo, Os; of La, Nd, Pr; of Mo, Os, Pr; of Nd, Pr, St; of Os, S, Ti; of Tl, Zr, Ba; of F, Tl, V; of K, Ba, Br; and of Zr, Sr, Os—elements or compounds.

In some versions, the nuclear adjuvant material has a coefficient of thermal expansion greater than or equal to that of commercial nuclear fuel. In some versions the nuclear adjuvant material has a coefficient of thermal expansion that is 10-200% or 50-150% of that of commercial nuclear fuel.

Group I isotopes useful as components in adjuvant material.

| | | | | |
|---|---|---|---|---|
| Ag¹⁰⁷ | Ag¹⁰⁹ | Ag¹¹¹ | Ag¹¹³ | Ag¹¹⁴ |
| Ag¹¹⁵ | Ag¹¹⁶ | Ag¹¹⁷ | Am²⁴¹ | Am²⁴² |
| Am²⁴³ | Am²⁴⁴ | As⁷⁵ | As⁷⁹ | Au¹⁹⁹ |
| B¹¹ | Ba¹³⁰ | Ba¹³¹ | Ba¹³² | Ba¹³³ |
| Ba¹³⁴ | Ba¹³⁵ | Ba¹³⁶ | Ba¹³⁷ | Ba¹³⁸ |
| Ba¹³⁹ | Ba¹⁴⁰ | Be⁷ | Be⁹ | Bi²⁰³ |
| Bi²⁰⁵ | Bi²⁰⁶ | Bi²⁰⁷ | | Br⁷⁶ |
| Br⁷⁹ | Br⁸⁰ | Br⁸¹ | C¹⁴ | Ca⁴¹ |
| Cd¹⁰⁷ | Cd¹⁰⁸ | Cd¹¹⁰ | Cd¹¹¹ | Cd¹¹² |
| Cd¹¹³ | Cd¹¹⁴ | Cd¹¹⁵ | Cd¹¹⁶ | Ce¹³⁶ |
| Ce¹³⁸ | Ce¹³⁹ | Ce¹⁴⁰ | Ce¹⁴¹ | Ce¹⁴² |
| Ce¹⁴³ | Ce¹⁴⁴ | | | |
| | Cl³⁵ | Cl³⁶ | Cl³⁷ | Cm²⁴⁵ |
| Co⁵⁵ | Co⁵⁸ | Co⁵⁹ | Cr⁴⁸ | Cr⁵⁰ |
| Cs¹³³ | Cs¹³⁴ | Cs¹³⁵ | Cs¹³⁶ | Cs¹³⁷ |
| Cu⁶⁴ | Dy¹⁵⁶ | Dy¹⁵⁸ | Dy¹⁶⁰ | Dy¹⁶¹ |
| Dy¹⁶² | Dy¹⁶³ | Dy¹⁶⁴ | Dy¹⁶⁶ | Er¹⁶² |
| Er¹⁶⁴ | Er¹⁶⁶ | Er¹⁶⁷ | Er¹⁶⁸ | Er¹⁶⁹ |
| Er¹⁷⁰ | Eu¹⁵¹ | Eu¹⁵² | Eu¹⁵³ | Eu¹⁵⁵ |
| Eu¹⁵⁶ | Eu¹⁵⁷ | F¹⁹ | Fe⁵² | Fe⁵³ |
| Fe⁵⁴ | Fe⁵⁸ | Ga⁶⁹ | Ga⁷⁰ | Ga⁷¹ |
| Gd¹⁵² | Gd¹⁵³ | Gd¹⁵⁴ | Gd¹⁵⁵ | Gd¹⁵⁶ |
| Gd¹⁵⁷ | Gd¹⁵⁸ | Gd¹⁵⁹ | Gd¹⁶⁰ | Ge⁶⁸ |
| Ge⁶⁹ | Ge⁷⁰ | Ge⁷¹ | Ge⁷² | Ge⁷³ |
| Ge⁷⁴ | Ge⁷⁵ | Ge⁷⁶ | Ge⁷⁷ | Ge⁷⁸ |
| Hf¹⁷⁴ | Hf¹⁷⁶ | Hf¹⁷⁷ | Hf¹⁷⁸ | Hf¹⁷⁹ |
| Hf¹⁸⁰ | Hg¹⁹⁷ | Ho¹⁶⁵ | I¹²⁴ | I¹²⁵ |
| I¹²⁷ | I¹²⁸ | I¹²⁹ | I¹³⁰ | I¹³¹ |
| I¹³² | I¹³³ | I¹³⁴ | I¹³⁵ | In¹¹³ |
| In¹¹⁴ | In¹¹⁵ | Ir¹⁹¹ | Ir¹⁹³ | K⁴¹ |
| K⁴³ | | La¹³⁸ | Li⁶ | Lu¹⁷⁵ |
| Lu¹⁷⁶ | Mg²⁴ | Mg²⁵ | Mg²⁶ | Mg²⁸ |
| Mn⁵⁵ | Mo¹⁰⁰ | Mo⁹² | Mo⁹⁴ | Mo⁹⁵ |
| Mo⁹⁶ | Mo⁹⁷ | Mo⁹⁸ | Mo⁹⁹ | N¹⁴ |
| N¹⁵ | Na²² | Na²³ | Na²⁴ | Nb⁹⁰ |
| Nb⁹⁴ | Nb⁹⁵ | Nb⁹⁶ | Nd¹⁴² | Nd¹⁴³ |
| Nd¹⁴⁴ | Nd¹⁴⁵ | Nd¹⁴⁶ | Nd¹⁴⁷ | Nd¹⁴⁸ |
| Nd¹⁴⁹ | Nd¹⁵⁰ | Ni⁵⁸ | Ni⁵⁹ | Ni⁶⁰ |
| Ni⁶¹ | Ni⁶² | Ni⁶³ | Ni⁶⁴ | |
| | | | O¹⁷ | O¹⁸ |
| Os¹⁸⁵ | Os¹⁸⁶ | Os¹⁸⁸ | Os¹⁸⁹ | Os¹⁹⁰ |
| Os¹⁹² | Os¹⁹⁴ | Pa²³¹ | Pa²³³ | Pb²⁰⁹ |
| Pb²¹⁰ | Pd¹⁰⁰ | Pd¹⁰¹ | Pd¹⁰² | Pd¹⁰³ |
| Pd¹⁰⁴ | Pd¹⁰⁵ | Pd¹⁰⁶ | Pd¹⁰⁷ | Pd¹⁰⁸ |
| Pd¹⁰⁹ | Pd¹¹⁰ | Pd¹¹² | Pm¹⁴⁷ | Pm¹⁴⁸ |
| Pm¹⁴⁹ | Pm¹⁵⁰ | Pm¹⁵¹ | Pr¹⁴¹ | Pr¹⁴² |
| Pr¹⁴³ | Pu²³⁶ | Pu²³⁷ | Pu²³⁸ | Pu²⁴⁰ |
| Pu²⁴² | Pu²⁴³ | Pu²⁴⁵ | Rb⁸³ | Rb⁸⁴ |
| Rb⁸⁵ | Rb⁸⁶ | Rb⁸⁷ | Re¹⁸² | Re¹⁸³ |
| Re¹⁸⁴ | Re¹⁸⁵ | Re¹⁸⁷ | Rh¹⁰³ | Rh¹⁰⁴ |
| Rh¹⁰⁵ | Ru¹⁰⁰ | Ru¹⁰¹ | Ru¹⁰² | Ru¹⁰³ |
| Ru¹⁰⁴ | Ru¹⁰⁵ | Ru¹⁰⁶ | Ru⁹⁶ | Ru⁹⁸ |
| Ru⁹⁹ | S³² | S³⁴ | S³⁵ | S³⁶ |
| Sb¹²¹ | Sb¹²² | Sb¹²³ | Sb¹²⁴ | Sb¹²⁵ |
| Sb¹²⁶ | Sc⁴⁵ | Se⁷² | Se⁷³ | Se⁷⁴ |
| Se⁷⁶ | Se⁷⁷ | Se⁷⁸ | Se⁷⁹ | Se⁸⁰ |
| Se⁸¹ | Se⁸² | Si²⁸ | Si³¹ | Si³² |
| Sm¹⁴⁴ | Sm¹⁴⁶ | Sm¹⁴⁷ | Sm¹⁴⁸ | Sm¹⁴⁹ |
| Sm¹⁵⁰ | Sm¹⁵¹ | Sm¹⁵² | Sm¹⁵³ | Sm¹⁵⁴ |
| Sm¹⁵⁶ | Sn¹¹² | Sn¹¹³ | Sn¹¹⁴ | Sn¹¹⁵ |
| Sn¹¹⁶ | Sn¹¹⁷ | Sn¹¹⁸ | Sn¹¹⁹ | Sn¹²⁰ |
| Sn¹²² | Sn¹²³ | Sn¹²⁵ | Sn¹²⁶ | Sr⁸² |
| Sr⁸⁴ | Sr⁸⁵ | Sr⁸⁶ | Sr⁸⁷ | Sr⁸⁸ |
| Sr⁸⁹ | Sr⁹⁰ | Sr⁹¹ | Ta¹⁸² | Tb¹⁵⁹ |
| Tc⁹⁹ | Te¹¹⁸ | Te¹¹⁹ | Te¹²⁰ | Te¹²² |
| Te¹²³ | Te¹²⁴ | Te¹²⁵ | Te¹²⁶ | Te¹²⁷ |
| Te¹²⁸ | Te¹³¹ | Te¹³² | Th²³¹ | Th²³² |
| Ti⁴⁵ | Ti⁴⁶ | Ti⁴⁷ | Ti⁴⁸ | Ti⁴⁹ |
| Ti⁵⁰ | Ti⁵¹ | Tm¹⁶⁸ | Tm¹⁶⁹ | Tm¹⁷² |
| U²³⁴ | U²³⁵ | U²³⁶ | U²³⁷ | U²³⁹ |
| V⁴⁹ | V⁵¹ | W¹⁷⁸ | W¹⁸⁰ | W¹⁸¹ |
| W¹⁸⁴ | W¹⁸⁶ | W¹⁸⁷ | Y⁸⁶ | Y⁸⁹ |
| Y⁹⁰ | Y⁹¹ | Yb¹⁶⁸ | Yb¹⁷⁰ | Yb¹⁷¹ |
| Yb¹⁷² | Yb¹⁷³ | Yb¹⁷⁴ | Yb¹⁷⁵ | Zn⁶² |
| Zn⁶⁵ | Zn⁷⁰ | Zn⁷² | Zr⁹⁰ | Zr⁹¹ |
| Zr⁹² | Zr⁹³ | Zr⁹⁴ | Zr⁹⁵ | Zr⁹⁶ |

Group II isotopes useful as components in adjuvant material.

| | | | | |
|---|---|---|---|---|
| Ag¹⁰⁷ | Ag¹⁰⁹ | Ag¹¹¹ | Ag¹¹³ | Ag¹¹⁴ |
| Ag¹¹⁵ | Ag¹¹⁶ | Ag¹¹⁷ | As⁷⁵ | As⁷⁹ |
| Au¹⁹⁹ | B¹¹ | Ba¹³⁰ | Ba¹³¹ | Ba¹³² |
| Ba¹³³ | Ba¹³⁴ | Ba¹³⁵ | Ba¹³⁶ | Ba¹³⁷ |
| Ba¹³⁸ | Ba¹³⁹ | Ba¹⁴⁰ | Be⁷ | Be⁹ |
| Bi²⁰³ | Bi²⁰⁵ | Bi²⁰⁶ | Bi²⁰⁷ | Br⁷⁶ |
| Br⁷⁹ | Br⁸⁰ | Br⁸¹ | C¹⁴ | Ca⁴¹ |
| Cd¹⁰⁷ | Cd¹⁰⁸ | Cd¹¹⁰ | Cd¹¹¹ | Cd¹¹² |
| Cd¹¹³ | Cd¹¹⁴ | Cd¹¹⁵ | Cd¹¹⁶ | Ce¹³⁶ |
| Ce¹³⁸ | Ce¹³⁹ | Ce¹⁴⁰ | Ce¹⁴¹ | Ce¹⁴² |
| Ce¹⁴³ | Ce¹⁴⁴ | Cl³⁵ | Cl³⁶ | Cl³⁷ |
| Cm²⁴⁵ | Co⁵⁵ | Co⁵⁸ | Co⁵⁹ | Cr⁴⁸ |
| Cr⁵⁰ | Cs¹³³ | Cs¹³⁴ | Cs¹³⁵ | Cs¹³⁶ |
| Cs¹³⁷ | Cu⁶⁴ | Dy¹⁵⁶ | Dy¹⁵⁸ | Dy¹⁶⁰ |
| Dy¹⁶¹ | Dy¹⁶² | Dy¹⁶³ | Dy¹⁶⁴ | Dy¹⁶⁶ |
| Er¹⁶² | Er¹⁶⁴ | Er¹⁶⁶ | Er¹⁶⁷ | Er¹⁶⁸ |
| Er¹⁶⁹ | Er¹⁷⁰ | Eu¹⁵¹ | Eu¹⁵² | Eu¹⁵³ |
| Eu¹⁵⁵ | Eu¹⁵⁶ | Eu¹⁵⁷ | F¹⁹ | Fe⁵² |
| Fe⁵³ | Fe⁵⁴ | Fe⁵⁸ | Ga⁶⁹ | Ga⁷⁰ |
| Ga⁷¹ | Gd¹⁵² | Gd¹⁵³ | Gd¹⁵⁴ | Gd¹⁵⁵ |
| Gd¹⁵⁶ | Gd¹⁵⁷ | Gd¹⁵⁸ | Gd¹⁵⁹ | Gd¹⁶⁰ |
| Ge⁶⁸ | Ge⁶⁹ | Ge⁷⁰ | Ge⁷¹ | Ge⁷² |
| Ge⁷³ | Ge⁷⁴ | Ge⁷⁵ | Ge⁷⁶ | Ge⁷⁷ |
| Ge⁷⁸ | Hf¹⁷⁴ | Hf¹⁷⁶ | Hf¹⁷⁷ | Hf¹⁷⁸ |
| Hf¹⁷⁹ | Hf¹⁸⁰ | Hg¹⁹⁷ | Ho¹⁶⁵ | I¹²⁴ |
| I¹²⁵ | I¹²⁷ | I¹²⁸ | I¹²⁹ | I¹³⁰ |
| I¹³¹ | I¹³² | I¹³³ | I¹³⁴ | I¹³⁵ |
| In¹¹³ | In¹¹⁴ | In¹¹⁵ | Ir¹⁹¹ | Ir¹⁹³ |
| K⁴¹ | K⁴³ | La¹³⁸ | Li⁶ | Lu¹⁷⁵ |
| Lu¹⁷⁶ | Mg²⁴ | Mg²⁵ | Mg²⁶ | Mg²⁸ |
| Mn⁵⁵ | Mo¹⁰⁰ | Mo⁹² | Mo⁹⁴ | Mo⁹⁵ |
| Mo⁹⁶ | Mo⁹⁷ | Mo⁹⁸ | Mo⁹⁹ | N¹⁴ |
| N¹⁵ | Na²² | Na²³ | Na²⁴ | Nb⁹⁰ |
| Nb⁹⁴ | Nb⁹⁵ | Nb⁹⁶ | Nd¹⁴² | Nd¹⁴³ |
| Nd¹⁴⁴ | Nd¹⁴⁵ | Nd¹⁴⁶ | Nd¹⁴⁷ | Nd¹⁴⁸ |
| Nd¹⁴⁹ | Nd¹⁵⁰ | Ni⁵⁸ | Ni⁵⁹ | Ni⁶⁰ |
| Ni⁶¹ | Ni⁶² | Ni⁶³ | Ni⁶⁴ | |
| | | | O¹⁷ | O¹⁸ |
| Os¹⁸⁵ | Os¹⁸⁶ | Os¹⁸⁸ | Os¹⁸⁹ | Os¹⁹⁰ |
| Os¹⁹² | Os¹⁹⁴ | Pa²³¹ | Pa²³³ | Pb²⁰⁹ |
| Pb²¹⁰ | Pd¹⁰⁰ | Pd¹⁰¹ | Pd¹⁰² | Pd¹⁰³ |
| Pd¹⁰⁴ | Pd¹⁰⁵ | Pd¹⁰⁶ | Pd¹⁰⁷ | Pd¹⁰⁸ |
| Pd¹⁰⁹ | Pd¹¹⁰ | Pd¹¹² | Pm¹⁴⁷ | Pm¹⁴⁸ |
| Pm¹⁴⁹ | Pm¹⁵⁰ | Pm¹⁵¹ | Pr¹⁴¹ | Pr¹⁴² |
| Pr¹⁴³ | Rb⁸³ | Rb⁸⁴ | Rb⁸⁵ | Rb⁸⁶ |
| Rb⁸⁷ | Re¹⁸² | Re¹⁸³ | Re¹⁸⁴ | Re¹⁸⁵ |
| Re¹⁸⁷ | Rh¹⁰³ | Rh¹⁰⁴ | Rh¹⁰⁵ | Ru¹⁰⁰ |
| Ru¹⁰¹ | Ru¹⁰² | Ru¹⁰³ | Ru¹⁰⁴ | Ru¹⁰⁵ |
| Ru¹⁰⁶ | Ru⁹⁶ | Ru⁹⁸ | Ru⁹⁹ | S³² |
| S³⁴ | S³⁵ | S³⁶ | Sb¹²¹ | Sb¹²² |
| Sb¹²³ | Sb¹²⁴ | Sb¹²⁵ | Sb¹²⁶ | Sc⁴⁵ |
| Se⁷² | Se⁷³ | Se⁷⁴ | Se⁷⁶ | Se⁷⁷ |
| Se⁷⁸ | Se⁷⁹ | Se⁸⁰ | Se⁸¹ | Se⁸² |
| Si²⁸ | Si³¹ | Si³² | Sm¹⁴⁴ | Sm¹⁴⁶ |
| Sm¹⁴⁷ | Sm¹⁴⁸ | Sm¹⁴⁹ | Sm¹⁵⁰ | Sm¹⁵¹ |
| Sm¹⁵² | Sm¹⁵³ | Sm¹⁵⁴ | Sm¹⁵⁶ | Sn¹¹² |
| Sn¹¹³ | Sn¹¹⁴ | Sn¹¹⁵ | Sn¹¹⁶ | Sn¹¹⁷ |
| Sn¹¹⁸ | Sn¹¹⁹ | Sn¹²⁰ | Sn¹²² | Sn¹²³ |
| Sn¹²⁵ | Sn¹²⁶ | Sr⁸² | Sr⁸⁴ | Sr⁸⁵ |
| Sr⁸⁶ | Sr⁸⁷ | Sr⁸⁸ | Sr⁸⁹ | Sr⁹⁰ |
| Sr⁹¹ | Ta¹⁸² | Tb¹⁵⁹ | Tc⁹⁹ | Te¹¹⁸ |
| Te¹¹⁹ | Te¹²⁰ | Te¹²² | Te¹²³ | Te¹²⁴ |
| Te¹²⁵ | Te¹²⁶ | Te¹²⁷ | Te¹²⁸ | Te¹³¹ |
| Te¹³² | Ti⁴⁵ | Ti⁴⁶ | Ti⁴⁷ | Ti⁴⁸ |
| Ti⁴⁹ | Ti⁵⁰ | Ti⁵¹ | Tm¹⁶⁸ | Tm¹⁶⁹ |
| Tm¹⁷² | U²³⁴ | U²³⁵ | U²³⁶ | U²³⁷ |
| U²³⁹ | V⁴⁹ | V⁵¹ | W¹⁷⁸ | W¹⁸⁰ |
| W¹⁸¹ | W¹⁸⁴ | W¹⁸⁶ | W¹⁸⁷ | Y⁸⁶ |
| Y⁸⁹ | Y⁹⁰ | Y⁹¹ | Yb¹⁶⁸ | Yb¹⁷⁰ |
| Yb¹⁷¹ | Yb¹⁷² | Yb¹⁷³ | Yb¹⁷⁴ | Yb¹⁷⁵ |
| Zn⁶² | Zn⁶⁵ | Zn⁷⁰ | Zn⁷² | Zr⁹⁰ |
| Zr⁹¹ | Zr⁹² | Zr⁹³ | Zr⁹⁴ | Zr⁹⁵ |
| Zr⁹⁶ | | | | |

The following is a list of isotopes that absorb a neutron in a nuclear reaction and emit a nuclear particle that is not a neutron. Compositions comprising the isotopes are useful components in a nuclear adjuvant material.

| Max_sig | At_energy | |
|---|---|---|
| ((barns)) | (MeV) | Reaction |
| 0.105 | 2.8 | BE-9(N,A′)HE-6 |
| 0.105 | 2.8 | BE-9(N,A)HE-6 |
| 0.036 | 4.15 | LI-6(N,P)HE-6 |
| 0.210 | 5.7 | F-19(N,A) |
| 0.229 | 6 | MG-25(N,A)NE-22 |
| 0.054 | 6 | RU-96(N,A)MO-93 |
| 0.312 | 7 | AR-36(N,A)S-33 |
| 0.299 | 8 | SE-74(N,P)AS-74 |
| 0.092 | 8 | AR-38(N,A)S-35 |
| 0.003 | 8 | CA-41(N,A′)AR-38 |
| 0.096 | 8.2 | S-34(N,A)SI-31 |
| 0.088 | 8.6741 | SE-74(N,A)GE-71 |
| 0.370 | 9.5 | S-32(N,P)P-32 |
| 0.056 | 9.96696 | BR-79(N,P)SE-79 |
| 0.238 | 10 | CO-58(N,P′) |
| 0.150 | 10 | CL-35(N,P′)S-35 |
| 0.113 | 10.1 | NA-23(N,P)NE-23 |
| 0.098 | 10.6 | NI-58(N,A′) |
| 0.614 | 11 | AR-36(N,P)CL-36 |
| 0.271 | 11 | V-49(N,P′)TI-49 |
| 0.267 | 11 | MG-24(N,A)NE-21 |
| 0.147 | 11 | CL-36(N,P′)S-36 |
| 0.097 | 11 | AR-38(N,P)CL-38 |
| 0.081 | 11 | CU-64(N,P′)NI-64 |
| 0.049 | 11 | GA-69(N,P)ZN-69 |
| 0.047 | 11 | GE-70(N,A′)ZN-67 |
| 0.020 | 11 | SE-76(N,A)GE-73 |
| 0.003 | 11 | MG-28(N,A)NE-25 |
| 0.344 | 12 | PD-102(N,P)RH-102 |
| 0.344 | 12 | PD-102(N,P′)RH-102 |
| 0.290 | 12 | TI-46(N,P′)SC-46 |
| 0.160 | 12 | AR-39(N,A′)S-36 |
| 0.157 | 12 | MO-92(N,P)NB-92 |
| 0.099 | 12 | GE-70(N,P)GA-70 |
| 0.099 | 12 | GE-70(N,P′)GA-70 |
| 0.017 | 12 | AR-40(N,A)S-37 |
| 0.164 | 12.1 | NA-23(N,A) |
| 0.048 | 12.424 | TE-118(N,P)SB-118 |
| 0.639 | 12.5 | FE-52(N,2P) |
| 0.301 | 12.5 | FE-53(N,2P) |
| 0.228 | 12.5 | MO-92(N,P′)NB-92 |
| 0.135 | 12.5 | CL-35(N,A′)P-32 |
| 0.056 | 12.5 | CO-59(N,P) |
| 0.024 | 12.5 | CL-37(N,P′)S-37 |
| 0.024 | 12.5 | CL-37(N,P)S-37 |
| 0.141 | 12.6049 | NI-60(N,P′)CO-60 |
| 0.017 | 12.792 | I-124(N,P)TE-124 |
| 0.051 | 12.837 | TE-119(N,P)SB-119 |
| 0.063 | 12.865 | XE-122(N,P)I-122 |
| 0.436 | 12.883 | CR-48(N,2P)TI-47 |
| 0.333 | 13 | ZN-62(N,2P)NI-61 |
| 0.305 | 13 | TI-46(N,P)SC-46 |
| 0.245 | 13 | NA-22(N,2A)N-15 |
| 0.184 | 13 | KR-79(N,P′)BR-79 |
| 0.180 | 13 | CL-36(N,A′)P-33 |
| 0.163 | 13 | RU-96(N,P)TC-96 |
| 0.151 | 13 | TI-47(N,P)SC-47 |
| 0.145 | 13 | TI-47(N,P′)SC-47 |
| 0.104 | 13 | SR-84(N,P)RB-84 |
| 0.104 | 13 | SR-84(N,P′)RB-84 |
| 0.100 | 13 | GE-71(N,P′)GA-71 |
| 0.092 | 13 | MG-26(N,A)NE-23 |
| 0.078 | 13 | RU-98(N,P)TC-98 |
| 0.074 | 13 | SE-76(N,P)AS-76 |
| 0.063 | 13 | KR-80(N,P)BR-80 |
| 0.049 | 13 | S-35(N,A′)SI-32 |
| 0.046 | 13 | GA-70(N,P′)ZN-70 |
| 0.046 | 13 | MN-55(N,P′)CR-55 |
| 0.040 | 13 | CL-37(N,A′)P-34 |
| 0.039 | 13 | MN-55(N,P)CR-55 |
| 0.038 | 13 | SN-112(N,P)IN-112 |
| 0.033 | 13 | B-11(N,A)LI-8 |
| 0.021 | 13 | RU-98(N,A)MO-95 |
| 0.010 | 13 | GE-72(N,A)ZN-69 |
| 0.001 | 13 | SI-31(N,A′)MG-28 |
| 0.024 | 13.249 | GE-69(N,2P)ZN-68 |
| 0.120 | 13.323 | KR-76(N,2P)SE-75 |
| 0.218 | 13.4 | MG-24(N,P)NA-24 |
| 0.040 | 13.5 | NI-59(N,2P) |
| 0.020 | 13.5 | N-15(N,P)C-15 |
| 0.004 | 13.563 | PD-101(N,2P)RU-100 |
| 0.063 | 13.699 | MG-24(N,A′)NE-21 |
| 0.096 | 13.736 | SE-73(N,2P)GE-72 |
| 0.046 | 13.739 | NA-24(N,P)NE-24 |
| 0.010 | 13.8 | B-11(N,A′)LI-8 |
| 0.169 | 13.876 | MG-24(N,P′)NA-24 |
| 0.130 | 14 | CD-107(N,P′)AG-107 |
| 0.081 | 14 | PD-103(N,P′)RH-103 |
| 0.077 | 14 | NI-61(N,P′)CO-61 |
| 0.070 | 14 | SR-85(N,P′)RB-85 |
| 0.055 | 14 | CU-64(N,A′)CO-61 |
| 0.049 | 14 | MG-25(N,P)NA-25 |
| 0.044 | 14 | SC-45(N,A)K-42 |
| 0.034 | 14 | GE-72(N,P)GA-72 |
| 0.034 | 14 | GE-72(N,P′)GA-72 |
| 0.031 | 14 | V-51(N,P)TI-51 |
| 0.028 | 14 | IN-114(N,P′)CD-114 |
| 0.018 | 14 | MO-94(N,A)ZR-91 |
| 0.062 | 14.1 | NI-60(N,A′) |
| 0.075 | 14.2 | MG-26(N,A′)NE-23 |
| 0.027 | 14.243 | XE-125(N,P)I-125 |
| 0.058 | 14.307 | MG-25(N,P′)NA-25 |
| 0.010 | 14.491 | KR-79(N,2P)SE-78 |
| 0.058 | 14.5 | TI-48(N,P′)SC-48 |
| 0.021 | 14.5 | FE-58(N,A) |
| 0.019 | 14.5 | KR-80(N,A)SE-77 |
| 0.009 | 14.5 | AS-79(N,P)GE-79 |
| 0.080 | 15 | SN-113(N,P)IN-113 |
| 0.080 | 15 | SN-113(N,P′)IN-113 |
| 0.075 | 15 | N-15(N,A)B-12 |
| 0.062 | 15 | TI-48(N,P)SC-48 |
| 0.057 | 15 | AR-39(N,P′)CL-39 |
| 0.056 | 15 | MO-94(N,P′)NB-94 |
| 0.052 | 15 | TI-49(N,P)SC-49 |
| 0.044 | 15 | SR-86(N,P)RB-86 |
| 0.042 | 15 | NI-61(N,A′) |
| 0.036 | 15 | ZR-90(N,P′)Y-90 |
| 0.032 | 15 | ZR-91(N,P′)Y-91 |
| 0.029 | 15 | MN-55(N,A)V-52 |
| 0.019 | 15 | MO-95(N,A′)ZR-92 |
| 0.014 | 15 | SN-112(N,A)CD-109 |
| 0.013 | 15 | BR-79(N,A)AS-76 |
| 0.012 | 15 | TI-45(N,2A)AR-38 |
| 0.010 | 15 | ZR-92(N,A)SR-89 |
| 0.009 | 15 | RU-100(N,A)MO-97 |
| 0.006 | 15 | B-11(N,P)BE-11 |
| 0.005 | 15.25 | RU-103(N,A)MO-100 |
| 0.019 | 15.281 | NA-24(N,A) |
| 0.014 | 15.38 | K-43(N,P)AR-43 |
| 0.013 | 15.382 | I-125(N,P)TE-125 |
| 0.036 | 15.4 | N-15(N,A′)B-12 |
| 0.012 | 15.5 | AS-75(N,A)GA-72 |
| 0.012 | 15.5 | AS-75(N,A′)GA-72 |
| 0.007 | 15.5 | GE-75(N,A)ZN-72 |
| 0.045 | 15.6397 | RB-85(N,P′)KR-85 |
| 0.010 | 15.6503 | MO-96(N,A)ZR-93 |
| 0.020 | 15.75 | NI-62(N,A′) |
| 0.002 | 15.8 | B-11(N,P′)BE-11 |
| 0.013 | 15.8327 | TE-120(N,A)SN-117 |
| 0.022 | 15.9528 | SR-87(N,P)RB-87 |
| 0.128 | 16 | V-49(N,A′)SC-46 |
| 0.057 | 16 | MO-94(N,P)NB-94 |
| 0.051 | 16 | NI-63(N,P′)CO-63 |
| 0.041 | 16 | NI-63(N,A′) |
| 0.039 | 16 | S-35(N,P′)P-35 |
| 0.033 | 16 | BR-80(N,A′)AS-77 |
| 0.031 | 16 | ZR-91(N,P)Y-91 |
| 0.027 | 16 | TE-120(N,P)SB-120 |
| 0.024 | 16 | KR-82(N,P)BR-82 |
| 0.022 | 16 | O-18(N,A)C-15 |
| 0.017 | 16 | NB-95(N,P)ZR-95 |
| 0.015 | 16 | ZR-93(N,P′)Y-93 |
| 0.013 | 16 | RH-103(N,A)TC-100 |
| 0.012 | 16 | KR-84(N,P)BR-84 |
| 0.011 | 16 | BA-130(N,A)XE-127 |
| 0.010 | 16 | MO-97(N,A′)ZR-94 |
| 0.010 | 16 | ZR-91(N,A)SR-88 |
| 0.008 | 16 | XE-130(N,P)I-130 |
| 0.007 | 16 | ZN-70(N,A)NI-67 |
| 0.007 | 16 | TC-99(N,A)NB-96 |
| 0.007 | 16 | TC-99(N,A′)NB-96 |
| 0.007 | 16 | NB-94(N,A)Y-91 |
| 0.006 | 16 | SE-78(N,A)GE-75 |
| 0.005 | 16 | NB-95(N,A)Y-92 |
| 0.004 | 16 | N-14(N,P′)C-14 |
| 0.002 | 16 | PR-143(N,A)LA-140 |
| 0.002 | 16 | CD-115(N,P)AG-115 |
| 0.013 | 16.116 | K-43(N,A)CL-40 |
| 0.021 | 16.152 | RB-83(N,A)BR-80 |
| 0.023 | 16.2438 | NB-94(N,P)ZR-94 |
| 0.030 | 16.25 | NI-62(N,P′)CO-62 |
| 0.009 | 16.331 | I-124(N,A)SB-121 |
| 0.004 | 16.5 | AS-79(N,A)GA-76 |
| 0.011 | 16.52 | NB-96(N,P)ZR-96 |
| 0.032 | 16.65 | MO-92(N,A′)ZR-89 |
| 0.019 | 16.7146 | RB-85(N,P)KR-85 |
| 0.005 | 16.75 | RU-105(N,A)MO-102 |
| 0.013 | 16.9202 | RU-99(N,A)MO-96 |
| 0.043 | 17 | MO-95(N,P)NB-95 |
| 0.043 | 17 | MO-95(N,P′)NB-95 |
| 0.040 | 17 | MG-26(N,P)NA-26 |
| 0.030 | 17 | MO-92(N,A)ZR-89 |
| 0.024 | 17 | GE-73(N,P)GA-73 |
| 0.024 | 17 | GE-73(N,P′)GA-73 |
| 0.024 | 17 | ZR-92(N,P′)Y-92 |
| 0.024 | 17 | BR-81(N,P)SE-81 |
| 0.018 | 17 | SR-86(N,A)KR-83 |
| 0.017 | 17 | TI-50(N,P)SC-50 |
| 0.012 | 17 | SE-77(N,A)GE-74 |
| 0.012 | 17 | SI-31(N,P′)AL-31 |
| 0.010 | 17 | KR-82(N,A)SE-79 |
| 0.009 | 17 | MO-97(N,A)ZR-94 |
| 0.008 | 17 | RU-102(N,A)MO-99 |
| 0.007 | 17 | MO-98(N,A)ZR-95 |
| 0.005 | 17 | AG-107(N,A)RH-104 |
| 0.005 | 17 | ZR-93(N,A)SR-90 |
| 0.004 | 17 | Y-91(N,A)RB-88 |
| 0.003 | 17 | PM-147(N,A)PR-144 |
| 0.003 | 17 | MO-99(N,A)ZR-96 |
| 0.003 | 17 | PM-148(N,A)PR-145 |
| 0.073 | 17.29 | O-17(N,P)N-17 |
| 0.002 | 17.37 | Y-86(N,2P)RB-85 |
| 0.004 | 17.4 | N-15(N,P′)C-15 |
| 0.021 | 17.5 | V-51(N,A)SC-48 |
| 0.004 | 17.5 | RU-104(N,A)MO-101 |
| 0.005 | 17.642 | NB-96(N,A)Y-93 |
| 0.008 | 17.65 | MO-98(N,A′)ZR-95 |
| 0.011 | 17.719 | RB-84(N,A)BR-81 |
| 0.008 | 17.842 | I-125(N,A)SB-122 |
| 0.050 | 18 | CD-108(N,P)AG-108 |
| 0.043 | 18 | SE-77(N,P)AS-77 |
| 0.034 | 18 | Y-90(N,A′)RB-87 |
| 0.029 | 18 | BA-133(N,P′)CS-133 |
| 0.029 | 18 | BA-133(N,P)CS-133 |
| 0.028 | 18 | ZR-92(N,P)Y-92 |
| 0.026 | 18 | RB-86(N,A)BR-83 |
| 0.026 | 18 | RB-86(N,A′)BR-83 |
| 0.019 | 18 | AG-109(N,P)PD-109 |
| 0.019 | 18 | AG-109(N,P′)PD-109 |
| 0.017 | 18 | SE-79(N,A)GE-76 |
| 0.016 | 18 | AG-107(N,P)PD-107 |
| 0.015 | 18 | TC-99(N,P)MO-99 |
| 0.015 | 18 | TC-99(N,P′)MO-99 |
| 0.015 | 18 | GA-71(N,P)ZN-71 |
| 0.015 | 18 | TE-122(N,P)SB-122 |
| 0.012 | 18 | TI-50(N,P′)SC-50 |
| 0.012 | 18 | RB-85(N,A)BR-82 |
| 0.011 | 18 | ZR-95(N,P′)Y-95 |
| 0.010 | 18 | RB-85(N,A′)BR-82 |
| 0.010 | 18 | SE-81(N,A′)GE-78 |
| 0.009 | 18 | TE-122(N,A)SN-119 |
| 0.008 | 18 | AG-109(N,A)RH-106 |
| 0.007 | 18 | EU-153(N,P)SM-153 |
| 0.007 | 18 | EU-153(N,P′)SM-153 |
| 0.007 | 18 | TE-124(N,A)SN-121 |
| 0.007 | 18 | ZR-94(N,A)SR-91 |
| 0.006 | 18 | TM-169(N,A′)HO-166 |
| 0.006 | 18 | ND-144(N,A)CE-141 |
| 0.006 | 18 | ND-144(N,A′)CE-141 |
| 0.006 | 18 | GE-74(N,A)ZN-71 |
| 0.005 | 18 | YB-171(N,A)ER-168 |
| 0.005 | 18 | CS-134(N,P)XE-134 |
| 0.004 | 18 | PR-141(N,A′)LA-138 |
| 0.003 | 18 | EU-152(N,A)PM-149 |
| 0.002 | 18 | PM-149(N,A)PR-146 |
| 0.001 | 18.052 | W-187(N,A) |
| 0.026 | 18.1565 | SE-78(N,P)AS-78 |
| 0.008 | 18.2094 | KR-84(N,A)SE-81 |
| 0.009 | 18.2833 | BR-81(N,A)AS-78 |
| 0.029 | 18.5 | MO-97(N,P′)NB-97 |
| 0.009 | 18.5 | SR-89(N,A)KR-86 |
| 0.005 | 18.5 | BA-138(N,A)XE-135 |
| 0.002 | 18.682 | BI-203(N,A)TL-200 |
| 0.017 | 18.8049 | RB-87(N,P)KR-87 |
| 0.021 | 18.9864 | NI-64(N,A′) |
| 0.049 | 19 | XE-128(N,P)I-128 |
| 0.045 | 19 | SN-114(N,P)IN-114 |
| 0.033 | 19 | BA-131(N,P′)CS-131 |
| 0.030 | 19 | MO-96(N,P)NB-96 |
| 0.029 | 19 | TI-49(N,P′)SC-49 |
| 0.028 | 19 | XE-126(N,P)I-126 |
| 0.028 | 19 | SR-88(N,P)RB-88 |
| 0.028 | 19 | AS-75(N,P)GE-75 |
| 0.028 | 19 | AS-75(N,P′)GE-75 |
| 0.026 | 19 | MO-97(N,P)NB-97 |
| 0.025 | 19 | BA-130(N,P)CS-130 |
| 0.024 | 19 | RH-103(N,P)RU-103 |
| 0.024 | 19 | RH-103(N,P′)RU-103 |
| 0.022 | 19 | AG-111(N,P′)PD-111 |
| 0.022 | 19 | AG-111(N,P)PD-111 |
| 0.021 | 19 | ZR-93(N,P)Y-93 |
| 0.018 | 19 | TE-124(N,P)SB-124 |
| 0.017 | 19 | TE-123(N,P)SB-123 |
| 0.017 | 19 | SE-79(N,P)AS-79 |
| 0.016 | 19 | SR-84(N,A)KR-81 |
| 0.015 | 19 | PR-141(N,P′)CE-141 |
| 0.015 | 19 | PR-141(N,P)CE-141 |
| 0.015 | 19 | RB-87(N,A)BR-84 |
| 0.014 | 19 | GE-74(N,P′)GA-74 |
| 0.014 | 19 | GE-74(N,P)GA-74 |
| 0.014 | 19 | SR-87(N,A)KR-84 |
| 0.014 | 19 | XE-129(N,P)I-129 |
| 0.013 | 19 | XE-126(N,A)TE-123 |
| 0.013 | 19 | XE-131(N,P′)I-131 |
| 0.013 | 19 | XE-131(N,P)I-131 |
| 0.012 | 19 | CE-138(N,A)BA-135 |
| 0.012 | 19 | I-135(N,A)SB-132 |
| 0.011 | 19 | TE-125(N,P)SB-125 |
| 0.009 | 19 | XE-128(N,A)TE-125 |
| 0.009 | 19 | SN-115(N,A)CD-112 |
| 0.008 | 19 | CD-111(N,A)PD-108 |
| 0.008 | 19 | AG-111(N,A)RH-108 |
| 0.007 | 19 | ZR-96(N,A)SR-93 |
| 0.007 | 19 | GD-158(N,A)SM-155 |
| 0.007 | 19 | ND-146(N,A′)CE-143 |
| 0.007 | 19 | XE-129(N,A)TE-126 |
| 0.007 | 19 | BA-132(N,A)XE-129 |
| 0.007 | 19 | PD-107(N,A)RU-104 |
| 0.006 | 19 | I-129(N,P)TE-129 |
| 0.006 | 19 | TB-159(N,A)EU-156 |
| 0.006 | 19 | YB-168(N,A)ER-165 |
| 0.006 | 19 | TE-126(N,A)SN-123 |
| 0.006 | 19 | CD-113(N,A)PD-110 |
| 0.005 | 19 | TE-125(N,A)SN-122 |
| 0.004 | 19 | CS-135(N,P)XE-135 |
| 0.004 | 19 | YB-170(N,A)ER-167 |
| 0.004 | 19 | 1-131(N,P)TE-131 |
| 0.004 | 19 | ER-162(N,A)DY-159 |
| 0.004 | 19 | LA-138(N,A)CS-135 |
| 0.003 | 19 | CS-136(N,P)XE-136 |
| 0.003 | 19 | SR-90(N,A)KR-87 |
| 0.003 | 19 | CS-133(N,A)I-130 |
| 0.003 | 19 | CS-133(N,A′)I-130 |
| 0.003 | 19 | ZR-95(N,A)SR-92 |
| 0.003 | 19 | ER-167(N,A)DY-164 |
| 0.002 | 19 | I-127(N,A)SB-124 |
| 0.002 | 19 | I-127(N,A′)SB-124 |
| 0.002 | 19 | CE-144(N,A)BA-141 |
| 0.001 | 19 | GE-78(N,A)ZN-75 |
| 0.043 | 19.033 | SE-80(N,A)GE-77 |
| 0.002 | 19.139 | MG-26(N,P′)NA-26 |
| 0.018 | 19.25 | KR-83(N,P)BR-83 |
| 0.007 | 19.299 | AR-42(N,A)S-39 |
| 0.024 | 19.5 | AR-40(N,P)CL-40 |
| 0.018 | 19.5 | Y-89(N,A)RB-86 |
| 0.018 | 19.5 | Y-89(N,A′)RB-86 |
| 0.016 | 19.5 | RU-103(N,P)TC-103 |
| 0.010 | 19.5 | GD-156(N,P′)EU-156 |
| 0.010 | 19.5 | GD-156(N,P)EU-156 |
| 0.005 | 19.52 | SB-121(N,A)IN-118 |
| 0.004 | 19.838 | RE-182(N,A)TA-179 |
| 0.003 | 19.877 | RE-184(N,A)TA-181 |
| 0.220 | 20 | IR-193(N,A′)RE-190 |
| 0.220 | 20 | IR-193(N,A)RE-190 |
| 0.147 | 20 | S-34(N,P)P-34 |
| 0.108 | 20 | SE-72(N,2P)GE-71 |
| 0.106 | 20 | CO-55(N,P + A)CR-51 |
| 0.088 | 20 | CD-111(N,P)AG-111 |
| 0.080 | 20 | EU-155(N,P)SM-155 |
| 0.079 | 20 | K-41(N,P)AR-41 |
| 0.062 | 20 | RU-99(N,P)TC-99 |
| 0.054 | 20 | AR-36(N,2A)SI-29 |
| 0.052 | 20 | CD-112(N,P)AG-112 |
| 0.051 | 20 | PD-105(N,P)RH-105 |
| 0.050 | 20 | FE-52(N,P + A) |
| 0.048 | 20 | AM-244(N,P)PU-244 |
| 0.047 | 20 | RB-86(N,P)KR-86 |
| 0.047 | 20 | RB-86(N,P′)KR-86 |
| 0.047 | 20 | AR-42(N,P)CL-42 |
| 0.046 | 20 | SN-115(N,P)IN-115 |
| 0.045 | 20 | PD-106(N,P)RH-106 |
| 0.044 | 20 | PD-104(N,P)RH-104 |
| 0.043 | 20 | CD-110(N,P)AG-110 |
| 0.042 | 20 | GE-68(N,2P)ZN-67 |
| 0.041 | 20 | SE-80(N,P)AS-80 |
| 0.040 | 20 | HF-174(N,P) |
| 0.040 | 20 | RU-101(N,P)TC-101 |
| 0.040 | 20 | RU-101(N,P′)TC-101 |
| 0.040 | 20 | NP-238(N,P)U-238 |
| 0.040 | 20 | KR-86(N,P)BR-86 |
| 0.040 | 20 | SN-116(N,P)IN-116 |
| 0.040 | 20 | PU-237(N,P)NP-237 |
| 0.039 | 20 | ZR-90(N,A′)SR-87 |
| 0.038 | 20 | I-129(N,P′)TE-129 |
| 0.038 | 20 | NP-236(N,P)U-236 |
| 0.038 | 20 | DY-158(N,P)TB-158 |
| 0.038 | 20 | I-130(N,P′)TE-130 |
| 0.038 | 20 | I-130(N,P)TE-130 |
| 0.037 | 20 | DY-156(N,P′)TB-156 |
| 0.037 | 20 | DY-156(N,P)TB-156 |
| 0.036 | 20 | CR-50(N,2P)TI-49 |
| 0.036 | 20 | NP-237(N,P)U-237 |
| 0.036 | 20 | EU-151(N,P)SM-151 |
| 0.036 | 20 | PD-108(N,P)RH-108 |
| 0.036 | 20 | SM-153(N,P)PM-153 |
| 0.034 | 20 | SM-150(N,P′)PM-150 |
| 0.034 | 20 | SM-150(N,P)PM-150 |
| 0.034 | 20 | HF-177(N,P) |
| 0.034 | 20 | PB-210(N,P)TL-210 |
| 0.034 | 20 | YB-168(N,P)TM-168 |
| 0.034 | 20 | CE-136(N,P′)LA-136 |
| 0.034 | 20 | CE-136(N,P)LA-136 |
| 0.033 | 20 | SM-144(N,P′)PM-144 |
| 0.033 | 20 | SM-144(N,P)PM-144 |
| 0.033 | 20 | IN-113(N,P)CD-113 |
| 0.032 | 20 | HF-176(N,P) |
| 0.032 | 20 | K-41(N,A)CL-38 |
| 0.031 | 20 | PD-107(N,P)RH-107 |
| 0.031 | 20 | AM-242(N,P)PU-242 |
| 0.031 | 20 | CE-138(N,P)LA-138 |
| 0.031 | 20 | SR-91(N,P)RB-91 |
| 0.030 | 20 | PR-142(N,P′)CE-142 |
| 0.030 | 20 | PR-142(N,P)CE-142 |
| 0.030 | 20 | NP-239(N,P)U-239 |
| 0.030 | 20 | ND-144(N,P′)PR-144 |
| 0.030 | 20 | ND-144(N,P)PR-144 |
| 0.030 | 20 | SN-117(N,P)IN-117 |
| 0.029 | 20 | PU-243(N,P)NP-243 |
| 0.028 | 20 | HF-179(N,P) |
| 0.027 | 20 | SB-126(N,P′)SN-126 |
| 0.027 | 20 | SB-126(N,P)SN-126 |
| 0.027 | 20 | SB-123(N,P)SN-123 |
| 0.027 | 20 | ND-142(N,P′)PR-142 |
| 0.027 | 20 | ND-142(N,P)PR-142 |
| 0.027 | 20 | DY-160(N,P)TB-160 |
| 0.027 | 20 | YB-170(N,P)TM-170 |
| 0.027 | 20 | TI-45(N,P + A)K-41 |
| 0.027 | 20 | FE-54(N,2P) |
| 0.026 | 20 | KR-85(N,A)SE-82 |
| 0.026 | 20 | KR-85(N,A′)SE-82 |
| 0.026 | 20 | SB-121(N,P)SN-121 |
| 0.025 | 20 | HF-178(N,P) |
| 0.025 | 20 | I-127(N,P)TE-127 |
| 0.025 | 20 | YB-171(N,P)TM-171 |
| 0.025 | 20 | AM-243(N,P)PU-243 |
| 0.025 | 20 | RU-96(N,2P)MO-95 |
| 0.025 | 20 | SN-120(N,P)IN-120 |
| 0.025 | 20 | OS-189(N,P)RE-189 |
| 0.025 | 20 | RB-87(N,P′)KR-87 |
| 0.024 | 20 | PD-110(N,P)RH-110 |
| 0.024 | 20 | KR-76(N,P + A)AS-72 |
| 0.024 | 20 | SM-144(N,A′)ND-141 |
| 0.024 | 20 | SM-144(N,A)ND-141 |
| 0.024 | 20 | ND-146(N,P′)PR-146 |
| 0.024 | 20 | ND-146(N,P)PR-146 |
| 0.024 | 20 | SN-118(N,P)IN-118 |
| 0.024 | 20 | W-180(N,P′)TA-180 |
| 0.024 | 20 | OS-194(N,P)RE-194 |
| 0.023 | 20 | I-127(N,P′)TE-127 |
| 0.023 | 20 | SM-147(N,P′)PM-147 |
| 0.023 | 20 | SM-147(N,P)PM-147 |
| 0.023 | 20 | PU-242(N,P)NP-242 |
| 0.023 | 20 | CF-250(N,P) |
| 0.023 | 20 | SE-72(N,P + A)GA-68 |
| 0.023 | 20 | DY-161(N,P)TB-161 |
| 0.022 | 20 | CD-113(N,P)AG-113 |
| 0.022 | 20 | ER-162(N,P)HO-162 |
| 0.022 | 20 | CE-139(N,P)LA-139 |
| 0.022 | 20 | OS-186(N,P)RE-186 |
| 0.022 | 20 | ZR-94(N,P)Y-94 |
| 0.022 | 20 | PU-236(N,P)NP-236 |
| 0.022 | 20 | SM-151(N,P)PM-151 |
| 0.021 | 20 | YB-172(N,P)TM-172 |
| 0.021 | 20 | ZR-90(N,A)SR-87 |
| 0.021 | 20 | MO-98(N,P′)NB-98 |
| 0.021 | 20 | ND-145(N,P′)PR-145 |
| 0.021 | 20 | ND-145(N,P)PR-145 |
| 0.021 | 20 | SM-152(N,P)PM-152 |
| 0.021 | 20 | RH-105(N,P)RU-105 |
| 0.021 | 20 | BA-132(N,P)CS-132 |
| 0.021 | 20 | CF-248(N,P) |
| 0.020 | 20 | ER-164(N,P)HO-164 |
| 0.020 | 20 | RH-104(N,P′)RU-104 |
| 0.020 | 20 | RU-105(N,P)TC-105 |
| 0.020 | 20 | ZR-96(N,P)Y-96 |
| 0.020 | 20 | HF-180(N,P) |
| 0.020 | 20 | SB-122(N,P′)SN-122 |
| 0.020 | 20 | CE-141(N,P)LA-141 |
| 0.020 | 20 | S-36(N,A)SI-33 |
| 0.020 | 20 | I-128(N,P′)TE-128 |
| 0.020 | 20 | YB-173(N,P)TM-173 |
| 0.019 | 20 | CE-140(N,P)LA-140 |
| 0.019 | 20 | SE-81(N,P′)AS-81 |
| 0.019 | 20 | SM-148(N,P′)PM-148 |
| 0.019 | 20 | SM-148(N,P)PM-148 |
| 0.019 | 20 | SM-149(N,P′)PM-149 |
| 0.019 | 20 | SM-149(N,P)PM-149 |
| 0.019 | 20 | XE-123(N,2P)TE-122 |
| 0.019 | 20 | CE-142(N,P)LA-142 |
| 0.019 | 20 | SR-89(N,P)RB-89 |
| 0.019 | 20 | OS-188(N,P)RE-188 |
| 0.019 | 20 | RU-106(N,P)TC-106 |
| 0.019 | 20 | XE-134(N,P)I-134 |
| 0.019 | 20 | SR-90(N,P)RB-90 |
| 0.019 | 20 | TE-132(N,P)SB-132 |
| 0.019 | 20 | ND-143(N,P′)PR-143 |
| 0.019 | 20 | ND-143(N,P)PR-143 |
| 0.018 | 20 | RU-100(N,P)TC-100 |
| 0.018 | 20 | ND-147(N,P′)PR-147 |
| 0.018 | 20 | ND-147(N,P)PR-147 |
| 0.018 | 20 | RE-185(N,P)W-185 |
| 0.018 | 20 | ER-167(N,P)HO-167 |
| 0.018 | 20 | MO-99(N,P)NB-99 |
| 0.018 | 20 | XE-132(N,P)I-132 |
| 0.017 | 20 | CD-114(N,P)AG-114 |
| 0.017 | 20 | OS-185(N,P′)RE-185 |
| 0.017 | 20 | RU-104(N,P)TC-104 |
| 0.017 | 20 | KR-85(N,P)BR-85 |
| 0.017 | 20 | KR-85(N,P′)BR-85 |
| 0.017 | 20 | ER-166(N,P)HO-166 |
| 0.017 | 20 | PD-109(N,P)RH-109 |
| 0.017 | 20 | PA-231(N,P′)TH-231 |
| 0.017 | 20 | U-234(N,P)PA-234 |
| 0.017 | 20 | SM-154(N,P)PM-154 |
| 0.016 | 20 | SM-146(N,P′)PM-146 |
| 0.016 | 20 | ND-148(N,P′)PR-148 |
| 0.016 | 20 | ND-148(N,P)PR-148 |
| 0.016 | 20 | ER-168(N,P)HO-168 |
| 0.016 | 20 | CS-133(N,P′)XE-133 |
| 0.016 | 20 | CS-133(N,P)XE-133 |
| 0.016 | 20 | PD-112(N,P)RH-112 |
| 0.016 | 20 | YB-174(N,P)TM-174 |
| 0.016 | 20 | ZR-95(N,P)Y-95 |
| 0.016 | 20 | SR-82(N,2P)KR-81 |
| 0.016 | 20 | CL-35(N,P + A)SI-31 |
| 0.016 | 20 | ZR-94(N,P′)Y-94 |
| 0.016 | 20 | SN-119(N,P)IN-119 |
| 0.015 | 20 | IR-191(N,P′)OS-191 |
| 0.015 | 20 | IR-191(N,P)OS-191 |
| 0.015 | 20 | HG-197(N,P′)AU-197 |
| 0.015 | 20 | W-181(N,P′)TA-181 |
| 0.015 | 20 | GD-152(N,P′)EU-152 |
| 0.015 | 20 | GD-152(N,P)EU-152 |
| 0.015 | 20 | BA-134(N,P)CS-134 |
| 0.015 | 20 | RE-187(N,P)W-187 |
| 0.015 | 20 | BR-76(N,2P)AS-75 |
| 0.014 | 20 | BE-7(N,2P)HE-6 |
| 0.014 | 20 | RU-102(N,P)TC-102 |
| 0.014 | 20 | ND-150(N,P′)PR-150 |
| 0.014 | 20 | ND-150(N,P)PR-150 |
| 0.014 | 20 | OS-190(N,P)RE-190 |
| 0.014 | 20 | GD-155(N,P′)EU-155 |
| 0.014 | 20 | GD-155(N,P)EU-155 |
| 0.014 | 20 | CE-143(N,P)LA-143 |
| 0.014 | 20 | PA-233(N,P′)TH-233 |
| 0.014 | 20 | PB-209(N,P)TL-209 |
| 0.014 | 20 | SN-123(N,P)IN-123 |
| 0.014 | 20 | GD-154(N,P′)EU-154 |
| 0.014 | 20 | GD-154(N,P)EU-154 |
| 0.013 | 20 | C-14(N,A)BE-11 |
| 0.013 | 20 | CD-116(N,P)AG-116 |
| 0.013 | 20 | TE-126(N,P)SB-126 |
| 0.013 | 20 | DY-162(N,P)TB-162 |
| 0.013 | 20 | I-132(N,P′)TE-132 |
| 0.013 | 20 | PU-237(N,A)U-234 |
| 0.013 | 20 | IN-115(N,P)CD-115 |
| 0.013 | 20 | EU-157(N,P′)SM-157 |
| 0.013 | 20 | EU-157(N,P)SM-157 |
| 0.013 | 20 | NI-64(N,P′)CO-64 |
| 0.013 | 20 | HO-165(N,P)DY-165 |
| 0.013 | 20 | CE-144(N,P)LA-144 |
| 0.013 | 20 | GD-157(N,P′)EU-157 |
| 0.013 | 20 | GD-157(N,P)EU-157 |
| 0.013 | 20 | TI-51(N,P)SC-51 |
| 0.012 | 20 | GD-153(N,P′)EU-153 |
| 0.012 | 20 | GD-153(N,P)EU-153 |
| 0.012 | 20 | ER-170(N,P)HO-170 |
| 0.012 | 20 | SE-82(N,P)AS-82 |
| 0.012 | 20 | W-178(N,P)TA-178 |
| 0.012 | 20 | TM-168(N,P′)ER-168 |
| 0.012 | 20 | PM-151(N,P′)ND-151 |
| 0.012 | 20 | PM-151(N,P)ND-151 |
| 0.012 | 20 | CF-251(N,P) |
| 0.012 | 20 | AG-114(N,P′)PD-114 |
| 0.011 | 20 | MO-98(N,P)NB-98 |
| 0.011 | 20 | RB-87(N,A′)BR-84 |
| 0.011 | 20 | I-130(N,A′)SB-127 |
| 0.011 | 20 | U-235(N,P′)PA-235 |
| 0.011 | 20 | TE-132(N,P′)SB-132 |
| 0.011 | 20 | SN-114(N,A)CD-111 |
| 0.011 | 20 | PM-150(N,P′)ND-150 |
| 0.011 | 20 | PD-100(N,2P)RU-99 |
| 0.011 | 20 | SM-156(N,P)PM-156 |
| 0.011 | 20 | CM-245(N,P)AM-245 |
| 0.011 | 20 | PU-245(N,A)U-242 |
| 0.011 | 20 | KR-86(N,A)SE-83 |
| 0.011 | 20 | IR-193(N,P′)OS-193 |
| 0.011 | 20 | IR-193(N,P)OS-193 |
| 0.011 | 20 | PM-147(N,P)ND-147 |
| 0.011 | 20 | N-14(N,T + 2A)HE-4 |
| 0.011 | 20 | MG-24(N,2A)O-17 |
| 0.011 | 20 | TH-232(N,P)AC-232 |
| 0.011 | 20 | AM-241(N,P)PU-241 |
| 0.010 | 20 | TE-131(N,P′)SB-131 |
| 0.010 | 20 | SR-88(N,A)KR-85 |
| 0.010 | 20 | BA-140(N,P)CS-140 |
| 0.010 | 20 | SN-116(N,A)CD-113 |
| 0.010 | 20 | OS-192(N,P)RE-192 |
| 0.010 | 20 | EU-152(N,P)SM-152 |
| 0.010 | 20 | TM-169(N,P′)ER-169 |
| 0.010 | 20 | PD-102(N,2P)RU-101 |
| 0.010 | 20 | GD-156(N,A′)SM-153 |
| 0.010 | 20 | GD-156(N,A)SM-153 |
| 0.010 | 20 | SN-125(N,P′)IN-125 |
| 0.010 | 20 | SN-125(N,P)IN-125 |
| 0.010 | 20 | BA-135(N,P)CS-135 |
| 0.010 | 20 | PU-243(N,A)U-240 |
| 0.010 | 20 | LU-175(N,A)TM-172 |
| 0.010 | 20 | LU-176(N,A)TM-173 |
| 0.010 | 20 | IN-113(N,A)AG-110 |
| 0.010 | 20 | GE-75(N,P)GA-75 |
| 0.010 | 20 | SB-125(N,A)IN-122 |
| 0.010 | 20 | GD-159(N,P′)EU-159 |
| 0.010 | 20 | M0-100(N,P′)NB-100 |
| 0.009 | 20 | I-134(N,P′)TE-134 |
| 0.009 | 20 | SN-122(N,P)IN-122 |
| 0.009 | 20 | TH-231(N,P)AC-231 |
| 0.009 | 20 | TH-232(N,P′)AC-232 |
| 0.009 | 20 | TA-182(N,A)LU-179 |
| 0.009 | 20 | PU-238(N,P)NP-238 |
| 0.009 | 20 | GD-160(N,A)SM-157 |
| 0.009 | 20 | DY-166(N,P)TB-166 |
| 0.009 | 20 | NP-237(N,A)PA-234 |
| 0.009 | 20 | ER-169(N,P′)HO-169 |
| 0.009 | 20 | I-133(N,P′)TE-133 |
| 0.009 | 20 | GE-76(N,P)GA-76 |
| 0.009 | 20 | I-129(N,A′)SB-126 |
| 0.009 | 20 | DY-160(N,A)GD-157 |
| 0.009 | 20 | ZR-96(N,P′)Y-96 |
| 0.009 | 20 | RE-185(N,A)TA-182 |
| 0.009 | 20 | AG-116(N,P′)PD-116 |
| 0.009 | 20 | TM-172(N,P)ER-172 |
| 0.009 | 20 | BA-138(N,P)CS-138 |
| 0.009 | 20 | NP-238(N,A)PA-235 |
| 0.009 | 20 | AG-113(N,P′)PD-113 |
| 0.009 | 20 | PM-148(N,P)ND-148 |
| 0.009 | 20 | PU-242(N,A)U-239 |
| 0.008 | 20 | U-235(N,P)PA-235 |
| 0.008 | 20 | SE-73(N,P + A)GA-69 |
| 0.008 | 20 | PU-240(N,P)NP-240 |
| 0.008 | 20 | AM-242(N,A)NP-239 |
| 0.008 | 20 | DY-163(N,P)TB-163 |
| 0.008 | 20 | S-36(N,P)P-36 |
| 0.008 | 20 | YB-175(N,P′)TM-175 |
| 0.008 | 20 | XE-134(N,A)TE-131 |
| 0.008 | 20 | TE-128(N,P)SB-128 |
| 0.008 | 20 | PM-149(N,P)ND-149 |
| 0.008 | 20 | NP-239(N,A)PA-236 |
| 0.008 | 20 | ND-149(N,P′)PR-149 |
| 0.008 | 20 | BI-207(N,A)TL-204 |
| 0.008 | 20 | PR-143(N,P)CE-143 |
| 0.007 | 20 | ND-149(N,P)PR-149 |
| 0.007 | 20 | SN-117(N,A)CD-114 |
| 0.007 | 20 | GD-152(N,A′)SM-149 |
| 0.007 | 20 | SI-32(N,P′)AL-32 |
| 0.007 | 20 | NA-22(N,T + A)O-16 |
| 0.007 | 20 | XE-132(N,A)TE-129 |
| 0.007 | 20 | SB-124(N,A)IN-121 |
| 0.007 | 20 | SM-152(N,A′)ND-149 |
| 0.007 | 20 | SM-152(N,A)ND-149 |
| 0.007 | 20 | BA-134(N,A)XE-131 |
| 0.007 | 20 | XE-135(N,A)TE-132 |
| 0.007 | 20 | BA-137(N,P)CS-137 |
| 0.007 | 20 | M0-100(N,P)NB-100 |
| 0.007 | 20 | RE-183(N,A)TA-180 |
| 0.007 | 20 | I-135(N,P)TE-135 |
| 0.007 | 20 | AM-243(N,A)NP-240 |
| 0.007 | 20 | GD-159(N,P)EU-159 |
| 0.007 | 20 | F-19(N,D + A) |
| 0.007 | 20 | BA-139(N,P′)CS-139 |
| 0.006 | 20 | RU-106(N,A)MO-103 |
| 0.006 | 20 | CF-249(N,P) |
| 0.006 | 20 | EU-156(N,P)SM-156 |
| 0.006 | 20 | GD-154(N,A′)SM-151 |
| 0.006 | 20 | GD-154(N,A)SM-151 |
| 0.006 | 20 | SB-126(N,A)IN-123 |
| 0.006 | 20 | SB-126(N,A′)IN-123 |
| 0.006 | 20 | GE-78(N,P)GA-78 |
| 0.006 | 20 | PU-236(N,A)U-233 |
| 0.006 | 20 | RH-105(N,A)TC-102 |
| 0.006 | 20 | TE-127(N,P)SB-127 |
| 0.006 | 20 | DY-162(N,A)GD-159 |
| 0.006 | 20 | W-178(N,A) |
| 0.006 | 20 | FE-52(N,P + D) |
| 0.006 | 20 | AG-115(N,P′)PD-115 |
| 0.006 | 20 | O-18(N,P)N-18 |
| 0.006 | 20 | SN-120(N,A)CD-117 |
| 0.006 | 20 | SN-119(N,A)CD-116 |
| 0.006 | 20 | GE-77(N,P)GA-77 |
| 0.006 | 20 | XE-133(N,P)I-133 |
| 0.006 | 20 | RE-187(N,A)TA-184 |
| 0.006 | 20 | U-234(N,A)TH-231 |
| 0.005 | 20 | BA-136(N,A)XE-133 |
| 0.005 | 20 | AU-199(N,P)PT-199 |
| 0.005 | 20 | BA-135(N,A)XE-132 |
| 0.005 | 20 | SN-118(N,A)CD-115 |
| 0.005 | 20 | YB-173(N,A)ER-170 |
| 0.005 | 20 | SB-124(N,P)SN-124 |
| 0.005 | 20 | ND-148(N,A′)CE-145 |
| 0.005 | 20 | ND-148(N,A)CE-145 |
| 0.005 | 20 | NP-236(N,A)PA-233 |
| 0.005 | 20 | LU-175(N,P)YB-175 |
| 0.005 | 20 | LU-176(N,P)YB-176 |
| 0.005 | 20 | IN-115(N,A)AG-112 |
| 0.005 | 20 | SB-123(N,A)IN-120 |
| 0.005 | 20 | EU-157(N,A′)PM-154 |
| 0.005 | 20 | EU-157(N,A)PM-154 |
| 0.005 | 20 | DY-164(N,A)GD-161 |
| 0.005 | 20 | I-129(N,A)SB-126 |
| 0.005 | 20 | SM-154(N,A)ND-151 |
| 0.005 | 20 | SB-125(N,P)SN-125 |
| 0.005 | 20 | CR-48(N,P + D)TI-46 |
| 0.004 | 20 | CS-137(N,P)XE-137 |
| 0.004 | 20 | TE-132(N,A′)SN-129 |
| 0.004 | 20 | CE-142(N,A)BA-139 |
| 0.004 | 20 | XE-135(N,P)I-135 |
| 0.004 | 20 | BK-249(N,P)CM-249 |
| 0.004 | 20 | NB-90(N,P + A)SR-86 |
| 0.004 | 20 | N-14(N,T + A)BE-8 |
| 0.004 | 20 | BA-137(N,A)XE-134 |
| 0.004 | 20 | XE-133(N,A)TE-130 |
| 0.004 | 20 | AG-117(N,P′)PD-117 |
| 0.004 | 20 | TE-128(N,A)SN-125 |
| 0.004 | 20 | ND-150(N,A)CE-147 |
| 0.004 | 20 | PM-151(N,A′)PR-148 |
| 0.004 | 20 | PM-151(N,A)PR-148 |
| 0.004 | 20 | CS-134(N,A)I-131 |
| 0.004 | 20 | MG-28(N,P)NA-28 |
| 0.003 | 20 | CS-135(N,A)I-132 |
| 0.003 | 20 | CO-58(N,P + A)CR-54 |
| 0.003 | 20 | TH-232(N,A′)RA-229 |
| 0.003 | 20 | I-131(N,A)SB-128 |
| 0.003 | 20 | SN-126(N,P)IN-126 |
| 0.003 | 20 | EU-156(N,A)PM-153 |
| 0.003 | 20 | GE-76(N,A)ZN-73 |
| 0.003 | 20 | PU-238(N,A)U-235 |
| 0.003 | 20 | CF-249(N,A) |
| 0.003 | 20 | PD-105(N,2P)RU-104 |
| 0.003 | 20 | U-235(N,A)TH-232 |
| 0.003 | 20 | CS-137(N,A)I-134 |
| 0.003 | 20 | ER-164(N,A)DY-161 |
| 0.003 | 20 | CS-136(N,A)I-133 |
| 0.003 | 20 | YB-172(N,A)ER-169 |
| 0.003 | 20 | GE-77(N,A)ZN-74 |
| 0.002 | 20 | ZN-72(N,A)NI-69 |
| 0.002 | 20 | BK-249(N,A)AM-246 |
| 0.002 | 20 | SN-125(N,A)CD-122 |
| 0.002 | 20 | SN-125(N,A′)CD-122 |
| 0.002 | 20 | SI-28(N,2P)MG-27 |
| 0.002 | 20 | BI-205(N,A)TL-202 |
| 0.002 | 20 | W-184(N,A′) |
| 0.002 | 20 | BI-206(N,A)TL-203 |
| 0.002 | 20 | CL-37(N,2P)P-36 |
| 0.002 | 20 | SE-82(N,A)GE-79 |
| 0.002 | 20 | GD-152(N,2P)SM-151 |
| 0.002 | 20 | MO-92(N,2P)ZR-91 |
| 0.002 | 20 | SN-122(N,A)CD-119 |
| 0.002 | 20 | KR-76(N,P + D)SE-74 |
| 0.002 | 20 | W-186(N,A′) |
| 0.002 | 20 | PD-104(N,2P)RU-103 |
| 0.002 | 20 | NB-94(N,2P)Y-93 |
| 0.002 | 20 | ER-166(N,A)DY-163 |
| 0.002 | 20 | CL-35(N,2P)P-34 |
| 0.002 | 20 | N-14(N,P + A)BE-10 |
| 0.002 | 20 | IR-191(N,A′)RE-188 |
| 0.002 | 20 | IR-191(N,A)RE-188 |
| 0.002 | 20 | SN-123(N,A)CD-120 |
| 0.002 | 20 | YB-174(N,A)ER-171 |
| 0.002 | 20 | U-236(N,A)TH-233 |
| 0.002 | 20 | SE-72(N,P + D)GE-70 |
| 0.002 | 20 | TH-232(N,A)RA-229 |
| 0.002 | 20 | SM-144(N,2P)ND-143 |
| 0.002 | 20 | BE-9(N,P′)LI-9 |
| 0.002 | 20 | BE-9(N,P)LI-9 |
| 0.001 | 20 | SR-82(N,P + A)BR-78 |
| 0.001 | 20 | U-239(N,A)TH-236 |
| 0.001 | 20 | MO-92(N,P + A)Y-88 |
| 0.001 | 20 | ZN-65(N,2P)NI-64 |
| 0.001 | 20 | TE-132(N,A)SN-129 |
| 0.001 | 20 | GE-68(N,P + D)ZN-66 |
| 0.001 | 20 | NI-58(N,P + D) |
| 0.001 | 20 | PD-107(N,2P)RU-106 |
| 0.001 | 20 | ER-168(N,A)DY-165 |
| 0.001 | 20 | KR-80(N,2P)SE-79 |
| 0.007 | 20.026 | U-236(N,P)PA-236 |
| 0.007 | 20.079 | U-237(N,P)PA-237 |

These lists are by no means exhaustive.

### Geometry

In some embodiments, the placement of the nuclear adjuvant regarding nuclear fuel placement is important. The nuclear adjuvant can be mixed with the material of the fuel pellet in various particle sizes. In some embodiments, the adjuvant particle size can be on the same scale as the fuel particle size. In other embodiments, the adjuvant particle size is greater or much greater than the fuel particle size. In even other embodiments, the D adjuvant particle size is much smaller or much smaller than the fuel particle size.

In some embodiments, the adjuvant material is segregated from the fuel. For instance, in some fuel-rod embodiments, the fuel rod comprises standard nuclear fuel pellets separated by plates or pellets of the adjuvant material. Another way of segregating the adjuvant material from the nuclear fuel is by lining the fuel-rod cladding with a hollow structure of adjuvant material, such as a hollow cylinder. In some embodiments, the adjuvant material is a monolithic structure inside of the fuel rod.

Adding the adjuvant material as part of a primary-loop additive is another example of segregating the adjuvant material from nuclear fuel. Fuel pellets can also be prepared by sputter coating the fuel with the nuclear adjuvant material, ion implanting the fuel with the nuclear adjuvant material or any other way of making materials known to those of ordinary skill in the art.

The behavior of the nuclear adjuvant material combined with the fuel pellet is dependent or strongly dependent on the geometrical relationship between the pellet and the adjuvant material.

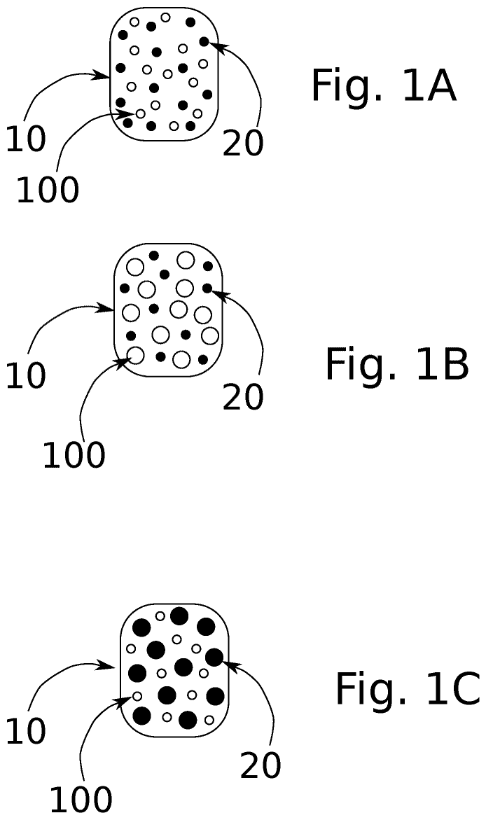

In FIGS. 1A, 1B, and 1C, pellet 10 shows nuclear adjuvant 100 with nuclear fuel 20. FIG. 1A shows a schematic view of a nuclear fuel pellet 10 with a nuclear adjuvant material 100 having a particle size commensurate with nuclear fuel 20. FIG. 1B is a schematic view of a nuclear fuel pellet 10 with adjuvant material 100 particle sizes much larger than the particle size of nuclear fuel 20. FIG. 1C depicts a nuclear fuel pellet 10 with adjuvant material particles 100 much smaller than nuclear fuel particles 20. These figures illustrate that nuclear adjuvant material particles can be much larger, larger, about the same size, smaller, or much smaller than nuclear fuel particles in some embodiments. Smaller means an order of magnitude smaller; much smaller means three orders of magnitude smaller. Larger means an order of magnitude larger; much larger means three orders of magnitude smaller

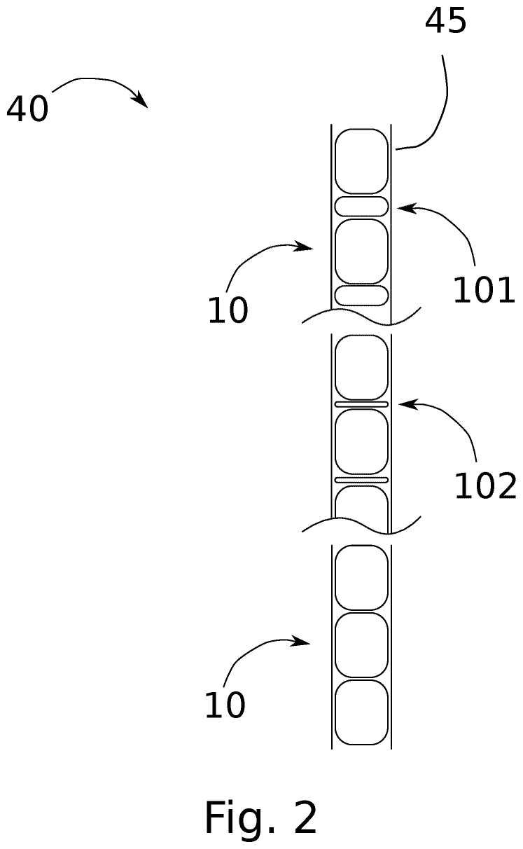

FIG. 2 is a schematic view of a nuclear fuel rod 40 with cladding 45. In this embodiment, pellet 10 is depicted inside fuel rod 40 along with a sizeable, monolithic, adjuvant pellet 101 or a small monolithic pellet 102. When the pellet is monolithic, it can have substantially any shape necessary to meet the fuel rod's geometry requirements and for the reactor. Fuel rod 40 is manufactured in any usual way known to those of ordinary skill in the art. The steps of adding nuclear adjuvant monolithic pieces into the fuel rod are shown. In invention embodiments in which the nuclear adjuvant is mixed with nuclear fuel, the mixture is prepared using any known way for preparing powder mixtures with care taken to substantially evenly distribute the adjuvant material particles or atoms throughout the fuel pellet. Those of ordinary skill in the art know myriad ways to prepare powder mixtures, including wet and dry processes. In some embodiments, the pellet is prepared such that the nuclear adjuvant material particles are atoms are distributed nonuniformly through the pellet.

The combination of pellets 10 and nuclear adjuvant material need not be uniform. Some sections of fuel rod 40 may contain only nuclear fuel pellets 10; some may contain fuel pellets 10 interleaved with monolithic pieces of nuclear adjuvant material 101, 102; some may contain fuel pellets 10 in which some of the fuel pellets are interleaved with monolithic pieces of nuclear adjuvant material 101,102; and some may contain sections of fuel rod 40 only containing monolithic nuclear adjuvant material 101, 102.

Any of a variety of well-known processes yield monolithic adjuvant materials. For instance, subjecting the constituent powders to powder manipulating or pressing techniques produces the material with or without applying heat. Other ways of manufacturing monolithic ceramic materials can produce the monolithic adjuvant material. The monolithic materials can be sintered.

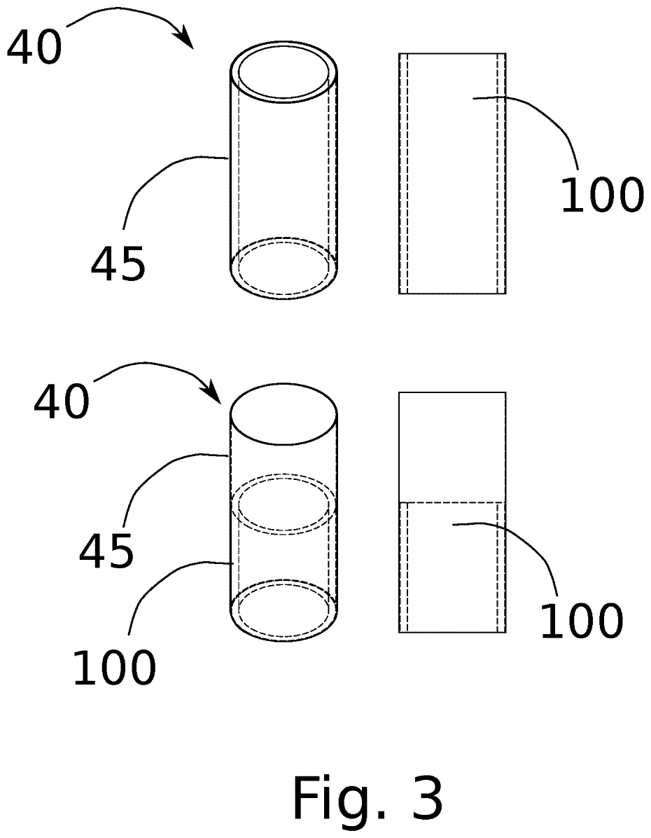

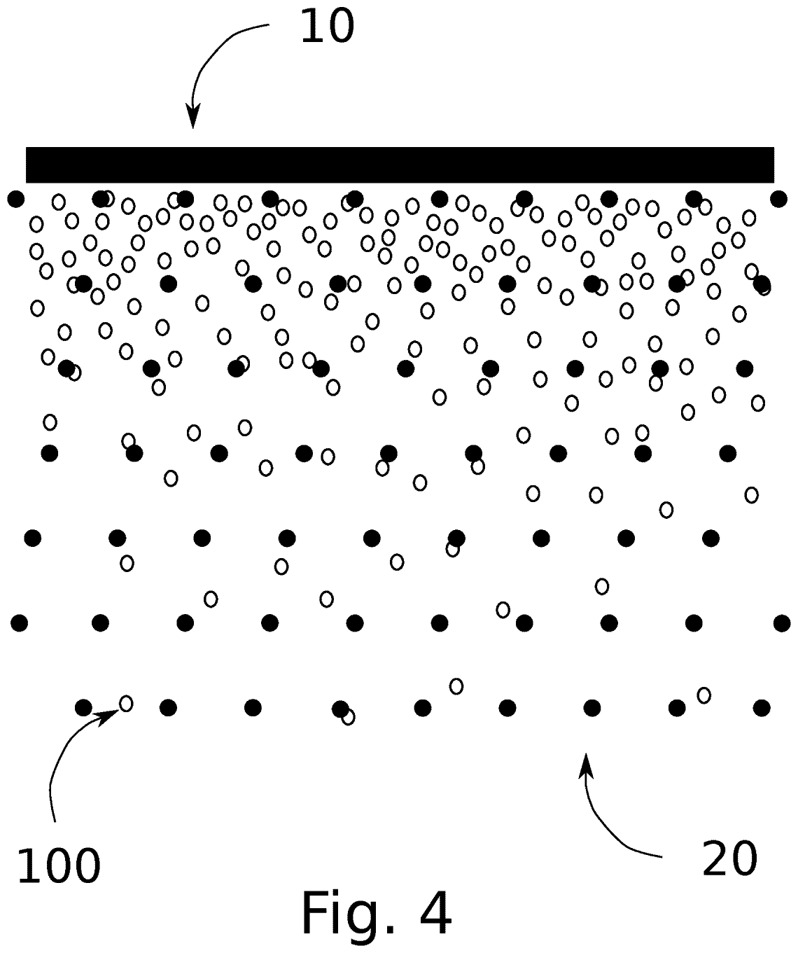

FIG. 3 shows a perspective view and a cross-section view of regions of the fuel rod 40 that are wholly or partially lined with a monolithic tube of nuclear adjuvant material.

FIG. 4 shows a schematic, highly magnified view of a pellet with implanted adjuvant material. The concentration of nuclear adjuvant material is highest at the pellet's outer surface and decreases at regions further from the surface. The figure depicts nuclear fuel as regularly distributed, but nuclear fuel is distributed irregularly in some embodiments.

Another method of alleviating reactor transients uses the adjuvant material to soak up enough surplus high-energy neutrons or other radiation produced in reactor transient events to slow the transient growth rate. Slowing the growth rate allows enough time for the fuel's negative coefficient of thermal reactivity to act.
Exemplar A1. A composition of matter, fuel pellet, or fuel rod comprising an assembly of atoms with different atomic masses, wherein the assembly exhibits a nuclear adjuvant effect.
Exemplar A2. The composition, pellet, or rod of exemplar A1, wherein the composition reacts with a neutron endothermically.
Exemplar A3. The composition, pellet, or rod of exemplar A2, wherein the assembly exhibits low neutron reaction coefficients at low neutron energies and high neutron reaction coefficients at high neutron energies.
Exemplar A4. The composition, pellet, or rod of exemplar A3, wherein the assembly exhibits neutron reaction coefficients at high neutron energies that are higher than the assembly exhibits at low neutron energies.
Exemplar A5. The composition, pellet, or rod of exemplar A4, wherein the atoms with different atomic masses comprise atoms selected from Ba, As, Br, Ce, Cl, Co, F, Ga, Ge, K, La, Mo, Nd, Os, Pr, S, Sr, Ti, Tl, V, and Zr.
Exemplar A6. The composition, pellet, or rod of exemplar A5, wherein the atoms with different atomic masses comprise atoms selected from As, Ce, Co, Ga, Ge, La, Mo, Nd, Os, Pr, Ti, V, and Zr.
Exemplar A7. The composition, pellet, or rod of exemplar A4, wherein the assembly comprises atoms with at least three different atomic masses.
Exemplar A8. The composition, pellet, or rod of exemplar A5, wherein the atoms with different atomic masses comprise atoms selected from Ba, As, Br, Ce, Cl, Co, F, Ga, Ge, K, La, Mo, Nd, Os, Pr, S, Sr, Ti, Tl, V, and Zr.
Exemplar A9. The composition, pellet, or rod of exemplar A6, wherein the atoms with different atomic masses comprise atoms selected from As, Ce, Co, Ga, Ge, La, Mo, Nd, Os, Pr, Ti, V, and Zr.
Exemplar A10. The composition, pellet, or rod of exemplar A4, wherein the assembly comprises a compound comprising atoms with two different atomic masses.
Exemplar A11. The composition, pellet, or rod of exemplar A10, wherein the atoms with different atomic masses comprise atoms selected from Ba, As, Br, Ce, Cl, Co, F, Ga, Ge, K, La, Mo, Nd, Os, Pr, S, Sr, Ti, Tl, V, and Zr.
Exemplar A12. The composition, pellet, or rod of exemplar A11, wherein the atoms with different atomic masses comprise atoms selected from As, Ce, Co, Ga, Ge, La, Mo, Nd, Os, Pr, Ti, V, and Zr.
Exemplar A13. The composition, pellet, or rod of exemplar A4, wherein the atoms with different atomic masses comprise atoms with three different atomic masses.
Exemplar A14. The composition, pellet, or rod of exemplar A13, wherein the atoms with different atomic masses comprise atoms selected from Ba, As, Br, Ce, Cl, Co, F, Ga, Ge, K, La, Mo, Nd, Os, Pr, S, Sr, Ti, Tl, V, and Zr.
Exemplar A15. The composition, pellet, or rod of exemplar A14, wherein the atoms with different atomic masses comprise atoms selected from As, Ce, Co, Ga, Ge, La, Mo, Nd, Os, Pr, Ti, V, and Zr.
Exemplar A16. The composition, pellet, or rod of exemplar A15, wherein the assembly reacts with a neutron endothermically.
Exemplar A17. The composition, pellet, or rod of exemplar A16, further comprising fissile material.
Exemplar A18. The composition, pellet, or rod of exemplar A17, further comprising a consumable absorber.
Exemplar A19. A composition of matter, fuel pellet, or fuel rod comprising an assembly of atoms with different atomic numbers the assembly exhibits a nuclear adjuvant effect.
Exemplar A20. The composition, pellet, or rod of exemplar A19, wherein the assembly reacts with the neutron endothermically.
Exemplar A21. The composition, pellet, or rod of exemplar A20, wherein the assembly exhibits low neutron reaction coefficient at a low neutron energy and a high neutron reaction coefficient at a high neutron energy.
Exemplar A22. The composition, pellet, or rod of exemplar A21, wherein the assembly exhibits neutron reaction coefficients at high neutron energies that are higher than the assembly exhibits at low neutron energies and.
Exemplar A23. The composition, pellet, or rod of exemplar A22, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A24. The composition, pellet, or rod of exemplar A23, wherein the atoms with different atomic numbers comprise atoms selected from As, Ce, Co, Ga, Ge, La, Mo, Nd, Os, Pr, Ti, V, and Zr.
Exemplar A25. The composition, pellet, or rod of exemplar A24, wherein the atoms with different atomic numbers comprise three atoms with different atomic numbers.
Exemplar A26. The composition, pellet, or rod of exemplar A25, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A27. The composition, pellet, or rod of exemplar A26, wherein the atoms with different atomic numbers comprise atoms selected from As, Ce, Co, Ga, Ge, La, Mo, Nd, Os, Pr, Ti, V, and Zr.
Exemplar A28. The composition, pellet, or rod of exemplar A21, wherein the assembly comprises a compound comprising atoms with two different atomic numbers.
Exemplar A29. The composition, pellet, or rod of exemplar A28, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A30. The composition, pellet, or rod of exemplar A29, wherein the atoms with different atomic numbers comprise atoms selected from As, Ce, Co, Ga, Ge, La, Mo, Nd, Os, Pr, Ti, V, and Zr.
Exemplar A31. The composition, pellet, or rod of exemplar A21, wherein the atoms with different atomic numbers comprise three atoms with different atomic numbers.
Exemplar A32. The composition, pellet, or rod of exemplar A31, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A33. The composition, pellet, or rod of exemplar A32, wherein the atoms with different atomic numbers comprise atoms selected from As, Ce, Co, Ga, Ge, La, Mo, Nd, Os, Pr, Ti, V, and Zr.
Exemplar A34. The composition, pellet, or rod of exemplar A33, wherein the assembly reacts with a neutron endothermically.
Exemplar A35. The composition, pellet, or rod of exemplar A34, further comprising fissile material.
Exemplar A36. The composition, pellet, or rod of exemplar A35, further comprising a consumable absorber.
Exemplar A37. A composition of matter, fuel pellet, or fuel rod comprising an assembly of one or more isotopes wherein the assembly exhibits a low neutron reaction coefficient at a low neutron energy and a high neutron reaction coefficient at a high neutron energy.
Exemplar A38. The composition, pellet, or rod of exemplar A37, wherein the assembly comprises atoms with different atomic numbers.
Exemplar A39. The composition, pellet, or rod of exemplar A38, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A40. The composition, pellet, or rod of exemplar A39, wherein the atoms with different atomic numbers comprise atoms selected from As, Ce, Co, Ga, Ge, La, Mo, Nd, Os, Pr, Ti, V, and Zr.
Exemplar A41. The composition, pellet, or rod of exemplar A37, wherein the atoms with different atomic numbers comprise three atoms with different atomic numbers.
Exemplar A42. The composition, pellet, or rod of exemplar A41, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A43. The composition, pellet, or rod of exemplar A42, wherein the atoms with different atomic numbers comprise atoms selected from As, Ce, Co, Ga, Ge, La, Mo, Nd, Os, Pr, Ti, V, and Zr.
Exemplar A44. The composition, pellet, or rod of exemplar A37, wherein the assembly comprises a compound comprising atoms with two different atomic numbers.
Exemplar A45. The composition, pellet, or rod of exemplar A38, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A46. The composition, pellet, or rod of exemplar A45, wherein the atoms with different atomic numbers comprise atoms selected from As, Ce, Co, Ga, Ge, La, Mo, Nd, Os, Pr, Ti, V, and Zr.
Exemplar A47. The composition, pellet, or rod of exemplar A37, wherein the assembly comprises a compound comprising atoms with three different atomic numbers.
Exemplar A48. The composition, pellet, or rod of exemplar A47, wherein the atoms with different atomic numbers comprise atoms selected from Ba, As, Br, Ce, Cl, Co, F, Ga, Ge, K, La, Mo, Nd, Os, Pr, S, Sr, Ti, Tl, V, and Zr.
Exemplar A49. The composition, pellet, or rod of exemplar A48, wherein the atoms with different atomic numbers comprise atoms selected from As, Ce, Co, Ga, Ge, La, Mo, Nd, Os, Pr, Ti, V, and Zr.
Exemplar A50. The composition, pellet, or rod of exemplar A49, wherein the assembly reacts with a neutron endothermically.
Exemplar A51. The composition, pellet, or rod of exemplar A50, further comprising fissile material.
Exemplar A52. The composition, pellet, or rod of exemplar A51, further comprising a consumable absorber.
Exemplar A53. A composition of matter, fuel pellet, or fuel rod comprising an assembly of atoms with the same atomic number, wherein the assembly exhibits a nuclear adjuvant effect.
Exemplar A54. The composition, pellet, or rod of exemplar A4, wherein the assembly comprises atoms with at least four, five, or six different atomic masses.
Exemplar A55. The composition, pellet, or rod of exemplar A24, wherein the atoms with different atomic numbers comprise four, five, or six atoms with different atomic numbers.
Exemplar A56. The composition, pellet, or rod of exemplar A37, wherein the atoms with different atomic numbers comprise four, five, or six atoms with different atomic numbers.
Exemplar B1. A composition of matter, fuel pellet, or fuel rod comprising an assembly of atoms with different atomic masses, wherein the assembly exhibits a nuclear adjuvant effect.
Exemplar B2. The composition, pellet, or rod of exemplar B1, wherein the composition reacts with a neutron endothermically.
Exemplar B3. The composition, pellet, or rod of exemplar B2, wherein the assembly exhibits a low neutron reaction coefficient at low neutron energy and a high neutron reaction coefficient at high neutron energy.
Exemplar B4. The composition, pellet, or rod of exemplar B3, wherein the assembly exhibits neutron reaction coefficients at high neutron energies that are higher than the assembly exhibits at low neutron energies.
Exemplar B5. The composition, pellet, or rod of exemplar B4, wherein the atoms with different atomic masses consist essentially of atoms selected from Ba, As, Br, Ce, Cl, Co, F, Ga, Ge, K, La, Mo, Nd, Os, Pr, S, Sr, Ti, Tl, V, and Zr.
Exemplar B6. The composition, pellet, or rod of exemplar B5, wherein the atoms with different atomic masses consist essentially of atoms selected from As, Ce, Co, Ga, Ge, La, Mo, Nd, Os, Pr, Ti, V, and Zr.
Exemplar B7. The composition, pellet, or rod of exemplar B4, wherein the assembly consist essentially of atoms with at least three different atomic masses.
Exemplar B8. The composition, pellet, or rod of exemplar B5, wherein the atoms with different atomic masses consist essentially of atoms selected from Ba, As, Br, Ce, Cl, Co, F, Ga, Ge, K, La, Mo, Nd, Os, Pr, S, Sr, Ti, Tl, V, and Zr.
Exemplar B9. The composition, pellet, or rod of exemplar B6, wherein the atoms with different atomic masses consist essentially of atoms selected from As, Ce, Co, Ga, Ge, La, Mo, Nd, Os, Pr, Ti, V, and Zr.
Exemplar B10. The composition, pellet, or rod of exemplar B4, wherein the assembly consist essentially of a compound comprising atoms with two different atomic masses.
Exemplar B11. The composition, pellet, or rod of exemplar B10, wherein the atoms with different atomic masses consist essentially of atoms selected from Ba, As, Br, Ce, Cl, Co, F, Ga, Ge, K, La, Mo, Nd, Os, Pr, S, Sr, Ti, Tl, V, and Zr.
Exemplar B12. The composition, pellet, or rod of exemplar B11, wherein the atoms with different atomic masses consist essentially of atoms selected from As, Ce, Co, Ga, Ge, La, Mo, Nd, Os, Pr, Ti, V, and Zr.
Exemplar B13. The composition, pellet, or rod of exemplar B4, wherein the atoms with different atomic masses consist essentially of atoms with three different atomic masses.
Exemplar B14. The composition, pellet, or rod of exemplar B13, wherein the atoms with different atomic masses consist essentially of atoms selected from Ba, As, Br, Ce, Cl, Co, F, Ga, Ge, K, La, Mo, Nd, Os, Pr, S, Sr, Ti, Tl, V, and Zr.
Exemplar B15. The composition, pellet, or rod of exemplar B14, wherein the atoms with different atomic masses consist essentially of atoms selected from As, Ce, Co, Ga, Ge, La, Mo, Nd, Os, Pr, Ti, V, and Zr.
Exemplar B16. The composition, pellet, or rod of exemplar B15, wherein the assembly reacts with a neutron endothermically.
Exemplar B17. The composition, pellet, or rod of exemplar B16, further comprising fissile material.
Exemplar B18. The composition, pellet, or rod of exemplar B17, further comprising a consumable absorber.
Exemplar B19. A composition of matter, fuel pellet, or fuel rod comprising an assembly of atoms with different atomic numbers the assembly exhibits a nuclear adjuvant effect.
Exemplar B20. The composition, pellet, or rod of exemplar B19, wherein the assembly reacts with the neutron endothermically.
Exemplar B21. The composition, pellet, or rod of exemplar B20, wherein the assembly exhibits low neutron reaction coefficient at a low neutron energy and a high neutron reaction coefficient at a high neutron energy.
Exemplar B22. The composition, pellet, or rod of exemplar B21, wherein the assembly exhibits neutron reaction coefficients at high neutron energies that are higher than the assembly exhibits at low neutron energies
Exemplar B23. The composition, pellet, or rod of exemplar B22, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B24. The composition, pellet, or rod of exemplar B23, wherein the atoms with different atomic numbers consist essentially of atoms selected from As, Ce, Co, Ga, Ge, La, Mo, Nd, Os, Pr, Ti, V, and Zr.
Exemplar B25. The composition, pellet, or rod of exemplar B24, wherein the atoms with different atomic numbers consist essentially of three atoms with different atomic numbers.
Exemplar B26. The composition, pellet, or rod of exemplar B25, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B27. The composition, pellet, or rod of exemplar B26, wherein the atoms with different atomic numbers consist essentially of atoms selected from As, Ce, Co, Ga, Ge, La, Mo, Nd, Os, Pr, Ti, V, and Zr.
Exemplar B28. The composition, pellet, or rod of exemplar B21, wherein the assembly consist essentially of a compound comprising atoms with two different atomic numbers.
Exemplar B29. The composition, pellet, or rod of exemplar B28, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B30. The composition, pellet, or rod of exemplar B29, wherein the atoms with different atomic numbers consist essentially of atoms selected from As, Ce, Co, Ga, Ge, La, Mo, Nd, Os, Pr, Ti, V, and Zr.
Exemplar B31. The composition, pellet, or rod of exemplar B21, wherein the atoms with different atomic numbers consist essentially of three atoms with different atomic numbers.
Exemplar B32. The composition, pellet, or rod of exemplar B31, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B33. The composition, pellet, or rod of exemplar B32, wherein the atoms with different atomic numbers consist essentially of atoms selected from As, Ce, Co, Ga, Ge, La, Mo, Nd, Os, Pr, Ti, V, and Zr.
Exemplar B34. The composition, pellet, or rod of exemplar B33, wherein the assembly reacts with a neutron endothermically.
Exemplar B35. The composition, pellet, or rod of exemplar B34, further comprising fissile material.
Exemplar B36. The composition, pellet, or rod of exemplar B35, further comprising a consumable absorber.
Exemplar B37. A composition of matter, fuel pellet, or fuel rod comprising an assembly of one or more isotopes wherein the assembly exhibits a low neutron reaction coefficient at a low neutron energy and a high neutron reaction coefficient at a high neutron energy.
Exemplar B38. The composition, pellet, or rod of exemplar B37, wherein the assembly consist essentially of atoms with different atomic numbers.
Exemplar B39. The composition, pellet, or rod of exemplar B38, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B40. The composition, pellet, or rod of exemplar B39, wherein the atoms with different atomic numbers consist essentially of atoms selected from As, Ce, Co, Ga, Ge, La, Mo, Nd, Os, Pr, Ti, V, and Zr.
Exemplar B41. The composition, pellet, or rod of exemplar B37, wherein the atoms with different atomic numbers consist essentially of three atoms with different atomic numbers.
Exemplar B42. The composition, pellet, or rod of exemplar B41, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B43. The composition, pellet, or rod of exemplar B42, wherein the atoms with different atomic numbers consist essentially of atoms selected from As, Ce, Co, Ga, Ge, La, Mo, Nd, Os, Pr, Ti, V, and Zr.
Exemplar B44. The composition, pellet, or rod of exemplar B37, wherein the assembly consist essentially of a compound comprising atoms with two different atomic numbers.
Exemplar B45. The composition, pellet, or rod of exemplar B38, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B46. The composition, pellet, or rod of exemplar B45, wherein the atoms with different atomic numbers consist essentially of atoms selected from As, Ce, Co, Ga, Ge, La, Mo, Nd, Os, Pr, Ti, V, and Zr.
Exemplar B47. The composition, pellet, or rod of exemplar B37, wherein the assembly consist essentially of a compound comprising atoms with three different atomic numbers.
Exemplar B48. The composition, pellet, or rod of exemplar B47, wherein the atoms with different atomic numbers consist essentially of atoms selected from Ba, As, Br, Ce, Cl, Co, F, Ga, Ge, K, La, Mo, Nd, Os, Pr, S, Sr, Ti, Tl, V, and Zr.
Exemplar B49. The composition, pellet, or rod of exemplar B48, wherein the atoms with different atomic numbers consist essentially of atoms selected from As, Ce, Co, Ga, Ge, La, Mo, Nd, Os, Pr, Ti, V, and Zr.
Exemplar B50. The composition, pellet, or rod of exemplar B49, wherein the assembly reacts with a neutron endothermically.
Exemplar B51. The composition, pellet, or rod of exemplar B50, further comprising fissile material.
Exemplar B52. The composition, pellet, or rod of exemplar B51, further comprising a consumable absorber.
Exemplar B53. A composition of matter, fuel pellet, or fuel rod comprising an assembly of atoms with the same atomic number, wherein the assembly exhibits a nuclear adjuvant effect.
Exemplar B54. The composition, pellet, or rod of exemplar B4, wherein the assembly consist essentially of atoms with at least four, five, or six different atomic masses.
Exemplar B55. The composition, pellet, or rod of exemplar B24, wherein the atoms with different atomic numbers consist essentially of four, five, or six atoms with different atomic numbers.
Exemplar B56. The composition, pellet, or rod of exemplar B37, wherein the atoms with different atomic numbers consist essentially of four, five, or six atoms with different atomic numbers.
Exemplar C1. A composition of matter, fuel pellet, or fuel rod comprising an assembly of atoms with different atomic masses, wherein the assembly exhibits a nuclear adjuvant effect.
Exemplar C2. The composition, pellet, or rod of exemplar C1, wherein the composition reacts with a neutron endothermically.
Exemplar C3. The composition, pellet, or rod of exemplar C2, wherein the assembly exhibits low neutron reaction coefficients at low neutron energies and high neutron reaction coefficients at high neutron energies.
Exemplar C4. The composition, pellet, or rod of exemplar C3, wherein the assembly exhibits neutron reaction coefficients at high neutron energies that are higher than the assembly exhibits at low neutron energies.
Exemplar C5. The composition, pellet, or rod of exemplar C4, wherein the atoms with different atomic masses consist of atoms selected from Ba, As, Br, Ce, Cl, Co, F, Ga, Ge, K, La, Mo, Nd, Os, Pr, S, Sr, Ti, Tl, V, and Zr.
Exemplar C6. The composition, pellet, or rod of exemplar C5, wherein the atoms with different atomic masses consist of atoms selected from As, Ce, Co, Ga, Ge, La, Mo, Nd, Os, Pr, Ti, V, and Zr.
Exemplar C7. The composition, pellet, or rod of exemplar C4, wherein the assembly consist of atoms with at least three different atomic masses.
Exemplar C8. The composition, pellet, or rod of exemplar C5, wherein the atoms with different atomic masses consist of atoms selected from Ba, As, Br, Ce, Cl, Co, F, Ga, Ge, K, La, Mo, Nd, Os, Pr, S, Sr, Ti, Tl, V, and Zr.
Exemplar C9. The composition, pellet, or rod of exemplar C6, wherein the atoms with different atomic masses consist of atoms selected from As, Ce, Co, Ga, Ge, La, Mo, Nd, Os, Pr, Ti, V, and Zr.
Exemplar C10. The composition, pellet, or rod of exemplar C4, wherein the assembly consist of a compound comprising atoms with two different atomic masses.
Exemplar C11. The composition, pellet, or rod of exemplar C10, wherein the atoms with different atomic masses consist of atoms selected from Ba, As, Br, Ce, Cl, Co, F, Ga, Ge, K, La, Mo, Nd, Os, Pr, S, Sr, Ti, Tl, V, and Zr.
Exemplar C12. The composition, pellet, or rod of exemplar C11, wherein the atoms with different atomic masses consist of atoms selected from As, Ce, Co, Ga, Ge, La, Mo, Nd, Os, Pr, Ti, V, and Zr.
Exemplar C13. The composition, pellet, or rod of exemplar C4, wherein the atoms with different atomic masses consist of atoms with three different atomic masses.
Exemplar C14. The composition, pellet, or rod of exemplar C13, wherein the atoms with different atomic masses consist of atoms selected from Ba, As, Br, Ce, Cl, Co, F, Ga, Ge, K, La, Mo, Nd, Os, Pr, S, Sr, Ti, Tl, V, and Zr.
Exemplar C15. The composition, pellet, or rod of exemplar C14, wherein the atoms with different atomic masses consist of atoms selected from As, Ce, Co, Ga, Ge, La, Mo, Nd, Os, Pr, Ti, V, and Zr.
Exemplar C16. The composition, pellet, or rod of exemplar C15, wherein the assembly reacts with a neutron endothermically.
Exemplar C17. The composition, pellet, or rod of exemplar C16, further comprising fissile material.
Exemplar C18. The composition, pellet, or rod of exemplar C17, further comprising a consumable absorber.
Exemplar C19. A composition of matter, fuel pellet, or fuel rod comprising an assembly of atoms with different atomic numbers the assembly exhibits a nuclear adjuvant effect.
Exemplar C20. The composition, pellet, or rod of exemplar C19, wherein the assembly reacts with the neutron endothermically.
Exemplar C21. The composition, pellet, or rod of exemplar C20, wherein the assembly exhibits low neutron reaction coefficient at a low neutron energy and a high neutron reaction coefficient at a high neutron energy.
Exemplar C22. The composition, pellet, or rod of exemplar C21, wherein the assembly exhibits neutron reaction coefficients at high neutron energies that are higher than the assembly exhibits at low neutron energies
Exemplar C23. The composition, pellet, or rod of exemplar C22, wherein the atoms with different atomic numbers consist of atoms selected from Ba, As, Br, Ce, Cl, Co, F, Ga, Ge, K, La, Mo, Nd, Os, Pr, S, Sr, Ti, Tl, V, and Zr.
Exemplar C24. The composition, pellet, or rod of exemplar C23, wherein the atoms with different atomic numbers consist of atoms selected from As, Ce, Co, Ga, Ge, La, Mo, Nd, Os, Pr, Ti, V, and Zr.
Exemplar C25. The composition, pellet, or rod of exemplar C24, wherein the atoms with different atomic numbers consist of three atoms with different atomic numbers.
Exemplar C26. The composition, pellet, or rod of exemplar C25, wherein the atoms with different atomic numbers consist of atoms selected from Ba, As, Br, Ce, Cl, Co, F, Ga, Ge, K, La, Mo, Nd, Os, Pr, S, Sr, Ti, Tl, V, and Zr.
Exemplar C27. The composition, pellet, or rod of exemplar C26, wherein the atoms with different atomic numbers consist of atoms selected from As, Ce, Co, Ga, Ge, La, Mo, Nd, Os, Pr, Ti, V, and Zr.
Exemplar C28. The composition, pellet, or rod of exemplar C21, wherein the assembly consist of a compound comprising atoms with two different atomic numbers.
Exemplar C29. The composition, pellet, or rod of exemplar C28, wherein the atoms with different atomic numbers consist of atoms selected from Ba, As, Br, Ce, Cl, Co, F, Ga, Ge, K, La, Mo, Nd, Os, Pr, S, Sr, Ti, Tl, V, and Zr.
Exemplar C30. The composition, pellet, or rod of exemplar C29, wherein the atoms with different atomic numbers consist of atoms selected from As, Ce, Co, Ga, Ge, La, Mo, Nd, Os, Pr, Ti, V, and Zr.
Exemplar C31. The composition, pellet, or rod of exemplar C21, wherein the atoms with different atomic numbers consist of three atoms with different atomic numbers.
Exemplar C32. The composition, pellet, or rod of exemplar C31, wherein the atoms with different atomic numbers consist of atoms selected from Ba, As, Br, Ce, Cl, Co, F, Ga, Ge, K, La, Mo, Nd, Os, Pr, S, Sr, Ti, Tl, V, and Zr.
Exemplar C33. The composition, pellet, or rod of exemplar C32, wherein the atoms with different atomic numbers consist of atoms selected from As, Ce, Co, Ga, Ge, La, Mo, Nd, Os, Pr, Ti, V, and Zr.
Exemplar C34. The composition, pellet, or rod of exemplar C33, wherein the assembly reacts with a neutron endothermically.
Exemplar C35. The composition, pellet, or rod of exemplar C34, further comprising fissile material.
Exemplar C36. The composition, pellet, or rod of exemplar C35, further comprising a consumable absorber.
Exemplar C37. A composition of matter, fuel pellet, or fuel rod comprising an assembly of one or more isotopes wherein the assembly exhibits a low neutron reaction coefficient at a low neutron energy and a high neutron reaction coefficient at a high neutron energy.
Exemplar C38. The composition, pellet, or rod of exemplar C37, wherein the assembly consist of atoms with different atomic numbers.
Exemplar C39. The composition, pellet, or rod of exemplar C38, wherein the atoms with different atomic numbers consist of atoms selected from Ba, As, Br, Ce, Cl, Co, F, Ga, Ge, K, La, Mo, Nd, Os, Pr, S, Sr, Ti, Tl, V, and Zr.
Exemplar C40. The composition, pellet, or rod of exemplar C39, wherein the atoms with different atomic numbers consist of atoms selected from As, Ce, Co, Ga, Ge, La, Mo, Nd, Os, Pr, Ti, V, and Zr.
Exemplar C41. The composition, pellet, or rod of exemplar C37, wherein the atoms with different atomic numbers consist of three atoms with different atomic numbers.
Exemplar C42. The composition, pellet, or rod of exemplar C41, wherein the atoms with different atomic numbers consist of atoms selected from Ba, As, Br, Ce, Cl, Co, F, Ga, Ge, K, La, Mo, Nd, Os, Pr, S, Sr, Ti, Tl, V, and Zr.
Exemplar C43. The composition, pellet, or rod of exemplar C42, wherein the atoms with different atomic numbers consist of atoms selected from As, Ce, Co, Ga, Ge, La, Mo, Nd, Os, Pr, Ti, V, and Zr.
Exemplar C44. The composition, pellet, or rod of exemplar C37, wherein the assembly consist of a compound comprising atoms with two different atomic numbers.
Exemplar C45. The composition, pellet, or rod of exemplar C38, wherein the atoms with different atomic numbers consist of atoms selected from Ba, As, Br, Ce, CI, Co, F, Ga, Ge, K, La, Mo, Nd, Os, Pr, S, Sr, Ti, Tl, V, and Zr.
Exemplar C46. The composition, pellet, or rod of exemplar C45, wherein the atoms with different atomic numbers consist of atoms selected from As, Ce, Co, Ga, Ge, La, Mo, Nd, Os, Pr, Ti, V, and Zr.
Exemplar C47. The composition, pellet, or rod of exemplar C37, wherein the assembly consist of a compound comprising atoms with three different atomic numbers.
Exemplar C48. The composition, pellet, or rod of exemplar C47, wherein the atoms with different atomic numbers consist of atoms selected from Ba, As, Br, Ce, Cl, Co, F, Ga, Ge, K, La, Mo, Nd, Os, Pr, S, Sr, Ti, Tl, V, and Zr.
Exemplar C49. The composition, pellet, or rod of exemplar C48, wherein the atoms with different atomic numbers consist of atoms selected from As, Ce, Co, Ga, Ge, La, Mo, Nd, Os, Pr, Ti, V, and Zr.
Exemplar C50. The composition, pellet, or rod of exemplar C49, wherein the assembly reacts with a neutron endothermically.
Exemplar C51. The composition, pellet, or rod of exemplar C50, further comprising fissile material.
Exemplar C52. The composition, pellet, or rod of exemplar C51, further comprising a consumable absorber.
Exemplar C53. A composition of matter, fuel pellet, or fuel rod comprising an assembly of atoms with the same atomic number, wherein the assembly exhibits a nuclear adjuvant effect.
Exemplar C54. The composition, pellet, or rod of exemplar C4, wherein the assembly consist of atoms with at least four, five, or six different atomic masses.
Exemplar C55. The composition, pellet, or rod of exemplar C24, wherein the atoms with different atomic numbers consist of four, five, or six atoms with different atomic numbers.
Exemplar C56. The composition, pellet, or rod of exemplar C37, wherein the atoms with different atomic numbers consist of four, five, or six atoms with different atomic numbers.
Exemplar D1. A composition of matter, fuel pellet, or fuel rod comprising an assembly of atoms with different atomic masses, wherein the assembly exhibits a nuclear adjuvant effect and wherein the assembly of atoms doesn't contain U, Pu, and Th.
Exemplar D2. The composition, pellet, or rod of exemplar D1, wherein the composition, pellet, or rod of exemplar reacts with a neutron endothermically.
Exemplar D3. The composition, pellet, or rod of exemplar D2, wherein the assembly exhibits low neutron reaction coefficients at low neutron energies and high neutron reaction coefficients at high neutron energies.
Exemplar D4. The composition, pellet, or rod of exemplar D3, wherein the assembly exhibits neutron reaction coefficients at high neutron energies that are higher than the assembly exhibits at low neutron energies.
Exemplar D7. The composition, pellet, or rod of exemplar D4, wherein the assembly comprises atoms with at least three different atomic masses.
Exemplar D10. The composition, pellet, or rod of exemplar D4, wherein the assembly comprises a compound comprising atoms with two different atomic masses.
Exemplar D17. The composition, pellet, or rod of exemplar D2, further comprising fissile material.
Exemplar D18. The composition, pellet, or rod of exemplar D17, further comprising a consumable absorber.
Exemplar D19. A composition of matter, fuel pellet, or fuel rod comprising an assembly of atoms with different atomic numbers wherein the assembly exhibits a nuclear adjuvant effect and wherein the assembly of atoms doesn't contain U, Pu, and Th.
Exemplar D20. The composition, pellet, or rod of exemplar D19, wherein the assembly reacts with the neutron endothermically.
Exemplar D21. The composition, pellet, or rod of exemplar D20, wherein the assembly exhibits low neutron reaction coefficient at a low neutron energy and a high neutron reaction coefficient at a high neutron energy.
Exemplar D22. The composition, pellet, or rod of exemplar D21, wherein the assembly exhibits neutron reaction coefficients at high neutron energies that are higher than the assembly exhibits at low neutron energies.
Exemplar D25. The composition, pellet, or rod of exemplar D22, wherein the atoms with different atomic numbers comprise three atoms with different atomic numbers.
Exemplar D34. The composition, pellet, or rod of exemplar D25, wherein the assembly reacts with a neutron endothermically.
Exemplar D35. The composition, pellet, or rod of exemplar D34, further comprising fissile material.
Exemplar D36. The composition, pellet, or rod of exemplar D35, further comprising a consumable absorber.
Exemplar D37. A composition of matter, fuel pellet, or fuel rod comprising an assembly of one or more isotopes wherein the assembly exhibits low neutron reaction coefficients at low neutron energies and high neutron reaction coefficients at high neutron energies and wherein the assembly of atoms doesn't contain U, Pu, and Th.
Exemplar D38. The composition, pellet, or rod of exemplar D37, wherein the assembly comprises atoms with different atomic numbers.
Exemplar D41. The composition, pellet, or rod of exemplar D37, wherein the atoms with different atomic numbers comprise three atoms with different atomic numbers.
Exemplar D44. The composition, pellet, or rod of exemplar D37, wherein the assembly comprises a compound comprising atoms with two different atomic
Exemplar D50. The composition, pellet, or rod of exemplar D44, wherein the assembly reacts with a neutron endothermically.
Exemplar D51. The composition, pellet, or rod of exemplar D50, further comprising fissile material.
Exemplar D52. The composition, pellet, or rod of exemplar D51, further comprising a consumable absorber.
Exemplar D54. The composition, pellet, or rod of exemplar D4, wherein the assembly comprises atoms with at least four, five, or six different atomic numbers.
Exemplar D55. The composition, pellet, or rod of exemplar D22, wherein the atoms with different atomic numbers comprise four, five, or six atoms with different atomic numbers.
Exemplar E1. A composition of matter, fuel pellet, or fuel rod comprising an assembly of atoms with different atomic masses, wherein the assembly exhibits a nuclear adjuvant effect and wherein at least one of the assembly of atoms has a higher high-energy-neutron absorption cross-section than U²³⁸ or U²³⁵.
Exemplar E2. The composition, pellet, or rod of exemplar E1, wherein the composition, pellet, or rod of exemplar reacts with a neutron endothermically.
Exemplar E3. The composition, pellet, or rod of exemplar E2, wherein the assembly exhibits low neutron reaction coefficients at low neutron energies and high neutron reaction coefficients at high neutron energies.
Exemplar E4. The composition, pellet, or rod of exemplar E3, wherein the assembly exhibits neutron reaction coefficients at high neutron energies that are higher than the assembly exhibits at low neutron energies.
Exemplar E7. The composition, pellet, or rod of exemplar E4, wherein the assembly comprises atoms with at least three different atomic masses.
Exemplar E10. The composition, pellet, or rod of exemplar E4, wherein the assembly comprises a compound comprising atoms with two different atomic masses.
Exemplar E17. The composition, pellet, or rod of exemplar E2, further comprising fissile material.
Exemplar E18. The composition, pellet, or rod of exemplar E17, further comprising a consumable absorber.
Exemplar E19. A composition of matter, fuel pellet, or fuel rod comprising an assembly of atoms with different atomic numbers wherein the assembly exhibits a nuclear adjuvant effect and wherein at least one of the assembly of atoms has a higher high-energy-neutron absorption cross-section than U²³⁸ or U²³⁵.
Exemplar E20. The composition, pellet, or rod of exemplar E19, wherein the assembly reacts with the neutron endothermically.
Exemplar E21. The composition, pellet, or rod of exemplar E20, wherein the assembly exhibits low neutron reaction coefficient at a low neutron energy and a high neutron reaction coefficient at a high neutron energy.
Exemplar E22. The composition, pellet, or rod of exemplar E21, wherein the assembly exhibits neutron reaction coefficients at high neutron energies that are higher than the assembly exhibits at low neutron energies.
Exemplar E25. The composition, pellet, or rod of exemplar E22, wherein the atoms with different atomic numbers comprise three atoms with different atomic numbers.
Exemplar E34. The composition, pellet, or rod of exemplar E25, wherein the assembly reacts with a neutron endothermically.
Exemplar E35. The composition, pellet, or rod of exemplar E34, further comprising fissile material.
Exemplar E36. The composition, pellet, or rod of exemplar E35, further comprising a consumable absorber.
Exemplar E37. A composition of matter, fuel pellet, or fuel rod comprising an assembly of one or more isotopes wherein the assembly exhibits a low neutron reaction coefficient at a low neutron energy and a high neutron reaction coefficient at a high neutron energy and wherein at least one of the assembly of atoms has a higher high-energy-neutron absorption cross-section than U²³⁸ or U²³⁵.
Exemplar E38. The composition, pellet, or rod of exemplar E37, wherein the assembly comprises atoms with different atomic numbers.
Exemplar E41. The composition, pellet, or rod of exemplar E37, wherein the atoms with different atomic numbers comprise three atoms with different atomic numbers.
Exemplar E44. The composition, pellet, or rod of exemplar E37, wherein the assembly comprises a compound comprising atoms with two different atomic
Exemplar E50. The composition, pellet, or rod of exemplar E44, wherein the assembly reacts with a neutron endothermically.
Exemplar E51. The composition, pellet, or rod of exemplar E50, further comprising fissile material.
Exemplar E52. The composition, pellet, or rod of exemplar E51, further comprising a consumable absorber.
Exemplar E54. The composition, pellet, or rod of exemplar E4, wherein the assembly comprises atoms with at least four, five, or six different atomic numbers.
Exemplar E55. The composition, pellet, or rod of exemplar E22, wherein the atoms with different atomic numbers comprise four, five, or six atoms with different atomic numbers.
Exemplar F1. A composition of matter, fuel pellet, or fuel rod comprising an assembly of atoms with different atomic masses, wherein
the assembly exhibits a nuclear adjuvant effect,
the assembly has a volume weighted average of high energy neutron absorption cross-sections of the atoms,
and
the volume weighted average multiplied by the volume % of adjuvant material in the fuel is 50-150, 75-125, or 90-110% of the high energy neutron absorption cross-section of U²³⁵ or U²³⁸ multiplied by the volume percent of U²³⁵ or U²³⁸.
Exemplar F2. The composition, pellet, or rod of exemplar F1, wherein the composition, pellet, or rod of reacts with a neutron endothermically.
Exemplar F3. The composition, pellet, or rod of exemplar F2, wherein the assembly exhibits low neutron reaction coefficients at low neutron energies and high neutron reaction coefficients at high neutron energies.
Exemplar F4. The composition, pellet, or rod of exemplar F3, wherein the assembly exhibits neutron reaction coefficients at high neutron energies that are higher than the assembly exhibits at low neutron energies.
Exemplar F7. The composition, pellet, or rod of exemplar F4, wherein the assembly comprises atoms with at least three different atomic masses.
Exemplar F10. The composition, pellet, or rod of exemplar F4, wherein the assembly comprises a compound comprising atoms with two different atomic masses.
Exemplar F17. The composition, pellet, or rod of exemplar F2, further comprising fissile material.
Exemplar F18. The composition, pellet, or rod of exemplar F17, further comprising a consumable absorber.
Exemplar F19. A composition of matter, fuel pellet, or fuel rod comprising an assembly of atoms with different atomic numbers wherein the assembly has a volume weighted average of high energy neutron absorption cross-sections of the atoms, the assembly exhibits a nuclear adjuvant effect, and the volume weighted average multiplied by the volume % of adjuvant material in the fuel is 50-150, 75-125, or 90-110% of the high energy neutron absorption cross-section of U²³⁵ or U²³⁸ multiplied by the volume percent of U²³⁵ or U²³⁸.
Exemplar F20. The composition, pellet, or rod of exemplar F19, wherein the assembly reacts with the neutron endothermically.
Exemplar F21. The composition, pellet, or rod of exemplar F20, wherein the assembly exhibits low neutron reaction coefficient at a low neutron energy and a high neutron reaction coefficient at a high neutron energy.
Exemplar F22. The composition, pellet, or rod of exemplar F21, wherein the assembly exhibits neutron reaction coefficients at high neutron energies that are higher than the assembly exhibits at low neutron energies.
Exemplar F25. The composition, pellet, or rod of exemplar F22, wherein the atoms with different atomic numbers comprise three atoms with different atomic numbers.
Exemplar F34. The composition, pellet, or rod of exemplar F25, wherein the assembly reacts with a neutron endothermically.
Exemplar F35. The composition, pellet, or rod of exemplar F34, further comprising fissile material.
Exemplar F36. The composition, pellet, or rod of exemplar F35, further comprising a consumable absorber.
Exemplar F37. A composition of matter, fuel pellet, or fuel rod comprising an assembly of one or more isotopes wherein
the assembly has a volume weighted average of high energy neutron absorption cross-sections of the atoms
the assembly exhibits low neutron reaction coefficients at low neutron energies and high neutron reaction coefficients at high neutron energies
and
the volume weighted average multiplied by the volume % of adjuvant material in the fuel is 50-150, 75-125, or 90-110% of the high energy neutron absorption cross-section of U²³⁵ or U²³⁸ multiplied by the volume percent of U²³⁵ or U²³⁸.

The above means the average of the assembly's high energy neutron absorption cross-sections adjusted for the relative volume composition of the overall material, including any uranium that is present.
Exemplar F38. The composition, pellet, or rod of exemplar F37, wherein the assembly comprises atoms with different atomic numbers.
Exemplar F41. The composition, pellet, or rod of exemplar F37, wherein the atoms with different atomic numbers comprise three atoms with different atomic numbers.
Exemplar F44. The composition, pellet, or rod of exemplar F37, wherein the assembly comprises a compound comprising atoms with two different atomic
Exemplar F50. The composition, pellet, or rod of exemplar F44, wherein the assembly reacts with a neutron endothermically.
Exemplar F51. The composition, pellet, or rod of exemplar F50, further comprising fissile material.
Exemplar F52. The composition, pellet, or rod of exemplar F51, further comprising a consumable absorber.
Exemplar F54. The composition, pellet, or rod of exemplar F4, wherein the assembly comprises atoms with at least four, five, or six different atomic numbers.
Exemplar F55. The composition, pellet, or rod of exemplar F22, wherein the atoms with different atomic numbers comprise four, five, or six atoms with different atomic numbers.
Exemplar G1. The composition, pellet, or rod of exemplars E1, D1, B1, C1, or F1 wherein the atoms are selected from Ag¹⁰⁷, Ag¹⁰⁹, Ag¹¹¹ Ag¹¹³, Ag¹¹⁴, Ag¹¹⁵, Ag¹¹⁶, Ag¹¹⁷, Am²⁴¹, Am²⁴², Am²⁴³, Am²⁴⁴, Ar³⁶, Ar³⁸, Ar³⁹, Ar⁴⁰, Ar⁴², As⁷⁵, As⁷⁹, Au¹⁹⁹, B¹¹, Ba¹³⁰, Ba¹³¹, Ba¹³², Ba¹³³, Ba¹³⁴, Ba¹³⁵, Ba¹³⁶, Ba¹³⁷, Ba¹³⁸, Ba¹³⁹, Ba¹⁴⁰, Be⁷, Be⁹, Bi²⁰³, Bi²⁰⁵, Bi²⁰⁶, Bi²⁰⁷, Bk²⁴⁹, Br⁷⁶, Br⁷⁹, Br⁸⁰, Br⁸¹, C¹⁴, Ca⁴¹, Cd¹⁰⁷, Cd¹⁰⁸, Cd¹¹⁰, Cd¹¹¹, Cd¹¹², Cd¹¹³, Cd¹¹⁴, Cd¹¹⁵, Cd¹¹⁶, Ce¹³⁶, Ce¹³⁸, Ce¹³⁹, Ce¹⁴⁰, Ce¹⁴¹, Ce¹⁴², Ce¹⁴³, Ce¹⁴⁴, Cl³⁵, C¹³⁶, C¹³⁷, Cm²⁴⁵, Co⁵⁵, Co⁵⁸, Co⁵⁹, Cr⁴⁸, Cr⁵⁰, Cs¹³³, Cs134, Cs¹³⁵, Cs¹³⁶, Cs¹³⁷, Cu⁶⁴, Dy¹⁵⁶, Dy¹⁵⁸, Dy¹⁶⁰, Dy¹⁶¹, Dy¹⁶², Dy¹⁶³, Dy¹⁶⁴, Dy¹⁶⁶, Er¹⁶², Er¹⁶⁴, Er¹⁶⁶, Er¹⁶⁷, Er¹⁶⁸, Er¹⁶⁹, Er¹⁷⁰, Eu¹⁵¹, Eu¹⁵², Eu¹⁵³, Eu¹⁵⁵, Eu¹⁵⁶, Eu¹⁵⁷, F¹⁹, Fe⁵², Fe⁵³, Fe⁵⁴, Fe⁵⁸, Ga⁶⁹, Ga⁷⁰, Ga⁷¹, Gd¹⁵², Gd¹⁵³, Gd¹⁵⁴, Gd¹⁵⁵, Gd¹⁵⁶, Gd¹⁵⁷, Gd¹⁵⁸, Gd¹⁵⁹, Gd¹⁶⁰, Ge⁶⁸, Ge⁶⁹, Ge⁷⁰, Ge⁷¹, Ge⁷², Ge⁷³, Ge⁷⁴, Ge⁷⁵, Ge⁷⁶, Ge⁷⁷, Ge⁷⁸, Hf¹⁷⁴, Hf¹⁷⁶, Hf¹⁷⁷, Hf¹⁷⁸, Hf¹⁷⁹, Hf¹⁸⁰, Hg¹⁹⁷, Ho¹⁶⁵, I¹²⁴, I¹²⁵, I¹²⁷, I¹²⁸, I¹²⁹, I¹³⁰, I¹³¹, I¹³², I¹³³, I¹³⁴, I¹³⁵, In¹¹³, In¹¹⁴, In¹¹⁵, Ir¹⁹¹, Ir¹⁹³, K⁴¹, K⁴³, La¹³⁸, Li⁶, Lu¹⁷⁵, Lu¹⁷⁶, Mg²⁴, Mg²⁵, Mg²⁶, Mg²⁸, Mn⁵⁵, Mo¹⁰⁰, Mo⁹², Mo⁹⁴, Mo⁹⁵, Mo⁹⁶, Mo⁹⁷, Mo⁹⁸, Mo⁹⁹, N¹⁴, N¹⁵, Na²², Na²³, Na²⁴, Nb⁹⁰, Nb⁹⁴, Nb⁹⁵, Nb⁹⁶, Nd¹⁴², Nd¹⁴³, Nd¹⁴⁴, Nd¹⁴⁵, Nd¹⁴⁶, Nd¹⁴⁷, Nd¹⁴⁸, Nd¹⁴⁹, Nd¹⁵⁰, Ni⁵⁸, Ni⁵⁹, Ni⁶⁰, Ni⁶¹, Ni⁶², Ni⁶³, Ni⁶⁴, O¹⁷, O¹⁸, Os¹⁸⁵, Os¹⁸⁶, Os¹⁸⁸, Os¹⁸⁹, Os¹⁹⁰, Os¹⁹², Os¹⁹⁴, Pa²³¹, Pa²³³, Pb²⁰⁹, Pb²¹⁰, Pd¹⁰⁰, Pd¹⁰¹, Pd¹⁰², Pd¹⁰³, Pd¹⁰⁴, Pd¹⁰⁵, Pd¹⁰⁶, Pd¹⁰⁷, Pd¹⁰⁸, Pd¹⁰⁹, Pd¹¹⁰, Pd¹¹², Pm¹⁴⁷, Pm¹⁴⁸, Pm¹⁴⁹, Pm¹⁵⁰, Pm¹⁵¹, Pr¹⁴¹, Pr¹⁴², Pr¹⁴³, Pu²³⁶, Pu²³⁷, Pu²³⁸, Pu²⁴⁰, Pu²⁴², Pu²⁴³, Pu²⁴⁵, Rb⁸³, Rb⁸⁴, Rb⁸⁵, Rb⁸⁶, Rb⁸⁷, Re¹⁸², Re¹⁸³, Re¹⁸⁴, Re¹⁸⁵, Re¹⁸⁷, Rh¹⁰³, Rh¹⁰⁴, Rh¹⁰⁵, Ru¹⁰⁰, Ru¹⁰¹, Ru¹⁰², Ru¹⁰³, Ru¹⁰⁴, Ru¹⁰⁵, Ru¹⁰⁶, Ru⁹⁶, Ru⁹⁸, Ru⁹⁹, S³², S³⁴, S³⁵, S³⁶, Sb¹²¹, Sb¹²², Sb¹²³, Sb¹²⁴, Sb¹²⁵, Sb¹²⁶, Sc⁴⁵, Se⁷², Se⁷³, Se⁷⁴, Se⁷⁶, Se⁷⁷, Se⁷⁸, Se⁷⁹, Se⁸⁰, Se⁸¹, Se⁸², Si²⁸, Si³¹, Si³², Sm¹⁴⁴, Sm¹⁴⁶, Sm¹⁴⁷, Sm¹⁴⁸, Sm¹⁴⁹, Sm¹⁵⁰, Sm¹⁵¹, Sm¹⁵², Sm¹⁵³, Sm¹⁵⁴, Sm¹⁵⁶, Sn¹¹², Sn¹¹³, Sn¹¹⁴, Sn¹¹⁵, Sn¹¹⁶, Sn¹¹⁷, Sn¹¹⁸, Sn¹¹⁹, Sn¹²⁰, Sn¹²², Sn¹²³, Sn¹²⁵, Sn¹²⁶, Sr⁸², Sr⁸⁴, Sr⁸⁵, Sr⁸⁶, Sr⁸⁷, Sr⁸⁸, Sr⁸⁹, Sr⁹⁰, Sr⁹¹, Ta¹⁸², Tb¹⁵⁹, Te¹¹⁸, Te¹¹⁹, Te¹²⁰, Te¹²², Te¹²³, Te¹²⁴, Te¹²⁵, Te¹²⁶, Te¹²⁷, Te¹²⁸, Te¹³¹, Te¹³², Th²³¹, Th²³², Ti⁴⁵, Ti⁴⁶, Ti⁴⁷, Ti⁴⁸, Ti⁴⁹, Ti⁵⁰, Ti⁵¹, Tm¹⁶⁸, Tm¹⁶⁹, Tm¹⁷², U²³⁴, U²³⁵, U²³⁶, U²³⁷, U²³⁹, V⁴⁹, V⁵¹, W¹⁷⁸, W¹⁸⁰, W¹⁸¹, W¹⁸⁴, W¹⁸⁶, W¹⁸⁷, Y⁸⁶, Y⁸⁹, Y⁹⁰, Y⁹¹, Yb¹⁶⁸, Yb¹⁷⁰, Yb¹⁷¹, Yb¹⁷², Yb¹⁷³, Yb¹⁷⁴, Yb¹⁷⁵, Zn⁶², Zn⁶⁵, Zn⁷⁰, Zn⁷², Zr⁹⁰, Zr⁹¹, Zr⁹², Zr⁹³, Zr⁹⁴, Zr⁹⁵, and Zr⁹⁶.
Exemplar G1. The composition, pellet, or rod of exemplars E1, D1, B1, C1, or F1 wherein the atoms are selected from Ag¹⁰⁷, Ag¹⁰⁹, Ag¹¹¹, Ag¹¹³, Ag¹¹⁴, Ag¹¹⁵, Ag¹¹⁶, Ag¹¹⁷, B¹¹, C¹⁴, Ca⁴¹, Cd¹⁰⁷, Cd¹⁰⁸, Cd¹¹⁰, Cd¹¹¹, Cd¹¹², Cd¹¹³, Cd¹¹⁴, Cd¹¹⁵, Cd¹¹⁶, Ce¹³⁶, Ce¹³⁸, Ce¹³⁹, Ce¹⁴⁰, Ce¹⁴¹, Ce¹⁴², Ce¹⁴³, Ce¹⁴⁴, Cl³⁵, Cl³⁶, Cl³⁷, Cm²⁴⁵, Co⁵⁵, Co⁵⁸, Co⁵⁹, Cr⁴⁸, Cr⁵⁰, Cs¹³³, Cs¹³⁴, Cs¹³⁵, Cs¹³⁶, Cs¹³⁷, Cu⁶⁴, Dy¹⁵⁶, Dy¹⁵⁸, Dy¹⁶⁰, Dy¹⁶¹, Dy¹⁶², Dy¹⁶³, Dy¹⁶⁴, Dy¹⁶⁶, Er¹⁶², Er¹⁶⁴, Er¹⁶⁶, Er¹⁶⁷, Er¹⁶⁸, Er¹⁶⁹, Er¹⁷⁰, Eu¹⁵¹, Eu¹⁵², Eu¹⁵³, Eu¹⁵⁵, Eu¹⁵⁶, Eu¹⁵⁷, F¹⁹, Fe⁵², Fe⁵³, Fe⁵⁴, Fe⁵⁸, Ga⁶⁹, Ga⁷⁰, Ga⁷¹, Gd¹⁵², Gd¹⁵³, Gd¹⁵⁴, Gd¹⁵⁵, Gd¹⁵⁶, Gd¹⁵⁷, Gd¹⁵⁸, Gd¹⁵⁹, Gd¹⁶⁰, Ge⁶⁸, Ge⁶⁹, Ge⁷⁰, Ge⁷¹, Ge⁷², Ge⁷³, Ge⁷⁴, Ge⁷⁵, Ge⁷⁶, Ge⁷⁷, Ge⁷⁸, Hf¹⁷⁴, Hf¹⁷⁶, Hf¹⁷⁷, Hf¹⁷⁸, Hf¹⁷⁹, Hf¹⁸⁰, Hg¹⁹⁷, Ho¹⁶⁵, In¹¹³, In¹¹⁴, In¹¹⁵, Ir¹⁹¹, Ir¹⁹³, K⁴¹, K⁴³, La¹³⁸, Li⁶, Lu¹⁷⁵, Lu¹⁷⁶, Mg²⁴, Mg²⁵, Mg²⁶, Mg²⁸, Mn⁵⁵, Mo¹⁰⁰, Mo⁹², Mo⁹⁴, Mo⁹⁵, Mo⁹⁶, Mo⁹⁷, Mo⁹⁸, Mo⁹⁹, N¹⁴, N¹⁵, Na²², Na²³, Na²⁴, Nb⁹⁰, Nb⁹⁴, Nb⁹⁵, Nb⁹⁶, Nd¹⁴², Nd¹⁴³, Nd¹⁴⁴, Nd¹⁴⁵, Nd¹⁴⁶, Nd¹⁴⁷, Nd¹⁴⁸, Nd¹⁴⁹, Nd¹⁵⁰, Ni⁵⁸, Ni⁵⁹, Ni⁶⁰, Ni⁶¹, Ni⁶², Ni⁶³, Ni⁶⁴, Np²³⁶, O¹⁷, O¹⁸, Os¹⁸⁵, Os¹⁸⁶, Os¹⁸⁸, Os¹⁸⁹, Os¹⁹⁰, Os¹⁹², Os¹⁹⁴, Pa²³¹, Pa²³³, Pb²⁰⁹, Pb²¹⁰, Pd¹⁰⁰, Pd¹⁰¹, Pd¹⁰², Pd¹⁰³, Pd¹⁰⁴, Pd¹⁰⁵, Pd¹⁰⁶, Pd¹⁰⁷, Pd¹⁰⁸, Pd¹⁰⁹, Pd¹¹⁰, Pd¹¹², Pm¹⁴⁷, Pm¹⁴⁸, Pm¹⁴⁹, Pm¹⁵⁰, Pm¹⁵¹, Pr¹⁴¹, Pr¹⁴², Pr¹⁴³, Pu²³⁶, Pu²³⁷, Pu²³⁸, Pu²⁴⁰, Pu²⁴², Pu²⁴³, Pu²⁴⁵, Rb⁸³, Rb⁸⁴, Rb⁸⁵, Rb⁸⁶, Rb⁸⁷, Re¹⁸², Re¹⁸³, Re¹⁸⁴, Re¹⁸⁵, Re¹⁸⁷, Rh¹⁰³, Rh¹⁰⁴, Rh¹⁰⁵, Ru¹⁰⁰, Ru¹⁰¹, Ru¹⁰², Ru¹⁰³, Ru¹⁰⁴, Ru¹⁰⁵, Ru¹⁰⁶, Ru⁹⁶, Ru⁹⁸, Ru⁹⁹, S³², S³⁴, S³⁵, S³⁶, Sb¹²¹, Sb¹²², Sb¹²³, Sb¹²⁴, Sb¹²⁵, Sb¹²⁶, Sc⁴⁵, Se⁷², Se⁷³, Se⁷⁴, Se⁷⁶, Se⁷⁷, Se⁷⁸, Se⁷⁹, Se⁸⁰, Se⁸¹, Se⁸², Si²⁸, Si³¹, Si³², Sm¹⁴⁴, Sm¹⁴⁶, Sm¹⁴⁷, Sm¹⁴⁸, Sm¹⁴⁹, Sm¹⁵⁰, Sm¹⁵¹, Sm¹⁵², Sm¹⁵³, Sm¹⁵⁴, Sm¹⁵⁶, Sn¹¹², Sn¹¹³, Sn¹¹⁴, Sn¹¹⁵, Sn¹¹⁶, Sn¹¹⁷, Sn¹¹⁸, Sn¹¹⁹, Sn¹²⁰, Sn¹²², Sn¹²³, Sn¹²⁵, Sn¹²⁶, Sr⁸², Sr⁸⁴, Sr⁸⁵, Sr⁸⁶, Sr⁸⁷, Sr⁸⁸, Sr⁸⁹, Sr⁹⁰, Sr⁹¹, Ta¹⁸², Tb¹⁵⁹, Te¹¹⁸, Te¹¹⁹, Te¹²⁰, Te¹²², Te¹²³, Te¹²⁴, Te¹²⁵, Te¹²⁶, Te¹²⁷, Te¹²⁸, Te¹³¹, Te¹³², Th²³¹, Th²³², Ti⁴⁵, Ti⁴⁶, Ti⁴⁷, Ti⁴⁸, Ti⁴⁹, Ti⁵⁰, Ti⁵¹, Tm¹⁶⁸, Tm¹⁶⁹, Tm¹⁷², U²³⁴, U²³⁵, U²³⁶, U²³⁷, U²³⁹, V⁴⁹, V⁵¹, W¹⁷⁸, W¹⁸⁰, W¹⁸¹, W¹⁸⁴, W¹⁸⁶, W¹⁸⁷, Y⁸⁶, Y⁸⁹, Y⁹⁰, Y⁹¹, Yb¹⁶⁸, Yb¹⁷⁰, Yb¹⁷¹, Yb¹⁷², Yb¹⁷³, Yb¹⁷⁴, Yb¹⁷⁵, Zn⁶², Zn⁶⁵, Zn⁷⁰, Zn⁷², Zr⁹⁰, Zr⁹¹, Zr⁹², Zr⁹³, Zr⁹⁴, Zr⁹⁵, and Zr⁹⁶.
Exemplar G2. The composition, pellet, or rod of exemplars E1, D1, B1, C1, or F1 wherein at least 10% of the atoms are selected from transition metals;
and
at least 10% of the atoms are selected from B, Al, Ga, In, C, Si, Ge, Sn, O, S, Se, Te.
Exemplar G3. The composition, pellet, or rod of exemplars E1, D1, B1, C1, or F1 wherein at least 10% of the atoms are selected from transition metals; at least 10% of the atoms are selected from B, Al, Ga, In, C, Si, Ge, Sn, O, S, Se, Te; and the assembly is a ceramic.

In some exemplars, a “nuclear adjuvant material” replaces 50%, 40%, 30%, 20%, 10%, 5%, 1%, 2×10-2%, 4×10-3%, 8×10-4%, 1.6×10-4%, 3.2×10-5%, 6.4×10-6%, 1.28×10-6%, 2.56×10-7%, 5.12×10-8%, 1.02×10-8%, 2.05×10-9%, or 4.1×10-10% of the fissile material in a commercial fuel pellet.

The previous description of several embodiments describes non-limiting examples that further illustrate the invention. All titles of sections in this document, including those appearing above, are not to be construed as limitations on the invention, but instead, they are provided to structure the illustrative description of the invention provided by the specification.

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, for example, a reference to “fluid” refers to one or more fluids, such as two or more fluids, three or more fluids, etc. When an aspect is said to include a list of components, the list is representative. If the component choice is limited explicitly to the list, the disclosure will say so. Listing components acknowledges that embodiments exist for each component and any combination of the components—including combinations that specifically exclude any one or any combination of the listed components. For example, “component A is chosen from A, B, or C” discloses embodiments with A, B, C, AB, AC, BC, and ABC. It also discloses (AB but not C), (AC but not B), and (BC but not A) as embodiments, for example. Combinations that one of ordinary skill in the art knows to be incompatible with each other or with the components' function in the invention are excluded from the invention, in some embodiments.

The terminology used is to describe particular example embodiments only and is not intended to be limiting. As used herein, the singular forms “a”, “an”, and “the” may be intended to include the plural forms unless the context indicates otherwise. The terms “comprises,” “comprising,” “including,” and “having” are inclusive and therefore specify the presence of stated features, integers, steps, operations, elements, or components but do not preclude the presence or addition of one or more other features, integers, steps, operations, elements, components, or groups thereof. The method steps, processes, and operations described are not construed as requiring their performance in the particular order discussed or illustrated unless specifically identified as an order of performance. It is also to be understood that additional or alternative steps may be employed,

When an element or layer is called being “on”, “engaged to”, “connected to” or “coupled to” another element or layer, it may be directly on, engaged, connected or coupled to the other element or layer, or intervening elements or layers may be present. When an element is called being “directly on,” “directly engaged to”, “directly connected to”, or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “or” includes any combinations of one or more of the associated listed items as used herein.

Although the terms first, second, third, etc. may be used to describe various moieties such as elements, components, regions, layers, or sections, these moieties should not be limited by these terms. These terms may only distinguish one element, component, region, layer, or section from another region, layer, or section. Terms such as “first,” “second,” and other numerical terms when used do not imply a sequence or order unless indicated by the context. Thus, a first element, component, region, layer, or section discussed below could be termed a second element, component, region, layer, or section without departing from the teachings of the example embodiments.

Spatially relative terms, such as “inner,” “outer,” “beneath”, “below”, “lower”, “above”, “upper” may be used herein for ease of description to describe one element or feature's relationship to another element(s) or feature(s) as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations), and the spatially relative descriptors used interpreted.

The preceding description of the embodiments has been provided for illustration and description. It is not intended to be exhaustive or to limit the invention. Individual elements or features of a particular embodiment rarely are limited to that embodiment, but, where applicable, are interchangeable and can be used in a selected embodiment, even if not explicitly shown or described. The same may also be varied. Such variations are not regarded as a departure from the invention, and all such modifications are intended to be included within the scope of the invention.

The embodiments of the invention described are exemplary. Numerous modifications, variations, and rearrangements can be readily envisioned to achieve substantially equivalent results, which are intended to be embraced within the invention's spirit and scope.

1-20. (canceled)

21. A nuclear fuel pellet, comprising:
first particles formed of a fissile material; and
second particles formed of a nuclear adjuvant material.

22. The nuclear fuel pellet of claim 21, wherein the nuclear adjuvant material comprises one or more atomic species able to absorb a portion of hardened neutrons generated within a nuclear reactor, wherein:
the hardened neutrons have energies greater than 800 keV and less than 20 MeV, and
the portion comprises between 0.00001% and 0.0001% of the hardened neutrons generated within the nuclear reactor.

23. The nuclear fuel pellet of claim 22, wherein the one or more atomic species undergo a nuclear reaction upon absorption of hardened neutrons, and a product of the nuclear reaction comprises less than 1% neutrons.

24. The nuclear fuel pellet of claim 22, wherein the one or more atomic species are selected from: Ba, As, Br, Ce, Cl, Co, F, Ga, Ge, K, La, Mo, Nd, Os, Pr, S, Sr, Ti, Tl, V, Zr, and combinations thereof.

25. The nuclear fuel pellet of claim 22, wherein the one or more atomic species comprise one or more isotopes selected from: Ag¹⁰⁷, Ag¹⁰⁹, Ag¹¹¹, Ag¹¹³, Ag¹¹⁴, Ag¹¹⁵, Ag¹¹⁶, Ag¹¹⁷, B¹¹, C¹⁴, Ca⁴¹, Cd¹⁰⁷, Cd¹⁰⁸, Cd¹¹⁰, Cd¹¹¹, Cd¹¹², Cd¹¹³, Cd¹¹⁴, Cd¹¹⁵, Cd¹¹⁶, Ce¹³⁶, Ce¹³⁸, Ce¹³⁹, Ce¹⁴⁰, Ce¹⁴¹, Ce¹⁴², Ce¹⁴³, Ce¹⁴⁴, C¹³⁵, Cl³⁶, C¹³⁷, Cm²⁴⁵, Co⁵⁵, Co⁵⁸, Co⁵⁹, Cr⁴⁸, Cr⁵⁰, Cs¹³³, Cs¹³⁴, Cs¹³⁸, Cs¹³⁶, Cs¹³⁷, Cu⁶⁴, Dy¹⁵⁶, Dy¹⁵⁸, Dy¹⁶⁰, Dy¹⁶¹, Dy¹⁶², Dy¹⁶³, Dy¹⁶⁴, Dy¹⁶⁶, Er¹⁶², Er¹⁶⁴, Er¹⁶⁶, Er¹⁶⁷, Er¹⁶⁸, Er¹⁶⁹, Er¹⁷⁰, Eu¹⁵¹, Eu¹⁵², Eu¹⁵³, Eu¹⁵⁵, Eu¹⁵⁶, Eu¹⁵⁷, F¹⁹, Fe⁵², Fe⁵³, Fe⁵⁴, Fe⁵⁵, Ga⁶⁹, Ga⁷⁰, Ga⁷¹, Gd¹⁵², Gd¹⁵³, Gd¹⁵⁴, Gd¹⁵⁵, Gd¹⁵⁶, Gd¹⁵⁷, Gd¹⁵⁸, Gd¹⁵⁹, Gd¹⁶⁰, Ge⁶⁸, Ge⁶⁹, Ge⁷⁰, Ge⁷¹, Ge⁷², Ge⁷³, Ge⁷⁴, Ge⁷⁵, Ge⁷⁶, Ge⁷⁷, Ge⁷⁸, Hf¹⁷⁴, Hf¹⁷⁶, Hf¹⁷⁷, Hf¹⁷⁸, Hf¹⁷⁹, Hf¹⁸⁰, Hg¹⁹⁷, Ho¹⁶⁵, In¹¹³, In¹¹⁴, In¹¹⁵, Ir¹⁹¹, Ir¹⁹³, K⁴¹, K⁴³, La¹³⁸, Li⁶, Lu¹⁷⁵, Lu¹⁷⁶, Mg²⁴, Mg²⁵, Mg²⁶, Mg²⁸, Mn⁵⁵, Mo⁹², Mo⁹⁴, Mo⁹⁵, Mo⁹⁶, Mo⁹⁷, Mo⁹⁸, Mo⁹⁹, Mo¹⁰⁰, N¹⁴, N¹⁵, Na²², Na²³, Na²⁴, Nb⁹⁰, Nb⁹⁴, Nb⁹⁵, Nb⁹⁶, Nd¹⁴², Nd¹⁴³, Nd¹⁴⁴, Nd¹⁴⁵, Nd¹⁴⁶, Nd¹⁴⁷, Nd¹⁴⁸, Nd¹⁴⁹, Nd¹⁵⁰, Ni⁵⁸, Ni⁵⁹, Ni⁶⁰, Ni⁶¹, Ni⁶², Ni⁶³, Ni⁶⁴, Np²³⁶, O¹⁷, O¹⁸, Os¹⁸⁵, Os¹⁸⁶, Os¹⁸⁸, Os¹⁸⁹, Os¹⁹⁰, Os¹⁹², Os¹⁹⁴, Pa²³¹, Pa²³³, Pb²⁰⁹, Pb²¹⁰, Pd¹⁰⁰, Pd¹⁰¹, Pd¹⁰², Pd¹⁰³, Pd¹⁰⁴, Pd¹⁰⁵, Pd¹⁰⁶, Pd¹⁰⁷, Pd¹⁰⁸, Pd¹⁰⁹, Pd¹¹⁰, Pd¹¹², Pm¹⁴⁷, Pm¹⁴⁸, Pm¹⁴⁹, Pm¹⁵⁰, Pm¹⁵¹, Pr¹⁴¹, Pr¹⁴², Pr¹⁴³, Pu²³⁶, Pu²³⁷, Pu²³⁸, Pu²⁴⁰, Pu²⁴², Pu²⁴³, Pu²⁴⁵, Rb⁸³, Rb⁸⁴, Rb⁸⁵, Rb⁸⁶, Rb⁸⁷, Re¹⁸², Re¹⁸³, Re¹⁸⁴, Re¹⁸⁵, Re¹⁸⁷, Rh¹⁰³, Rh¹⁰⁴, Rh¹⁰⁵, Ru¹⁰⁰, Ru¹⁰¹, Ru¹⁰², Ru¹⁰³, Ru¹⁰⁴, Ru¹⁰⁵, Ru¹⁰⁶, Ru⁹⁶, Ru⁹⁸, Ru⁹⁹, S³², S³⁴, S³⁵, S³⁶, Sb¹²¹, Sb¹²², Sb¹²³, Sb¹²⁴, Sb¹²⁵, Sb¹²⁶, Sc⁴⁵, Se⁷², Se⁷³, Se⁷⁴, Se⁷⁶, Se⁷⁷, Se⁷⁸, Se⁷⁹, Se⁸⁰, Se⁸¹, Se⁸², Si²⁸, Si³¹, Si³², Sm¹⁴⁴, Sm¹⁴⁶, Sm¹⁴⁷, Sm¹⁴⁸, Sm¹⁴⁹, Sm¹⁵⁰, Sm¹⁵¹, Sm¹⁵², Sm¹⁵³, Sm¹⁵⁴, Sm¹⁵⁶, Sn¹¹², Sn¹¹³, Sn¹¹⁴, Sn¹¹⁵, Sn¹¹⁶, Sn¹¹⁷, Sn¹¹⁸, Sn¹¹⁹, Sn¹²⁰, Sn¹²², Sn¹²³, Sn¹²⁵, Sn¹²⁶, Sr⁸², Sr⁸⁴, Sr⁸⁵, Sr⁸⁶, Sr⁸⁷, Sr⁸⁸, Sr⁸⁹, Sr⁹⁰, Sr⁹¹, Ta¹⁸², Tb¹⁵⁹, Te¹¹⁸, Te¹¹⁹, Te¹²⁰, Te¹²², Te¹²³, Te¹²⁴, Te¹²⁵, Te¹²⁶, Te¹²⁷, Te¹²⁸, Te¹³¹, Te¹³², Th²³¹, Th²³², Ti⁴⁵, Ti⁴⁶, Ti⁴⁷, Ti⁴⁸, Ti⁴⁹, Ti⁵⁰, Ti⁵¹, Tm¹⁶⁸, Tm¹⁶⁹, Tm¹⁷², U²³⁴, U²³⁵, U²³⁶, U²³⁷, U²³⁹, V⁴⁹, V⁵¹, W¹⁷⁸, W¹⁸⁰, W¹⁸¹, W¹⁸⁴, W¹⁸⁶, W¹⁸⁷, Y⁸⁶, Y⁸⁹, Y⁹⁰, Y⁹¹, Yb¹⁶⁸, Yb¹⁷⁰, Yb¹⁷¹, Yb¹⁷², Yb¹⁷³, Yb¹⁷⁴, Yb¹⁷⁵, Zn⁶², Zn⁶⁵, Zn⁷⁰, Zn⁷², Zr⁹⁰, Zr⁹¹, Zr⁹², Zr⁹³, Zr⁹⁴, Zr⁹⁵, Zr⁹⁶, and combinations thereof.

26. The nuclear fuel pellet of claim 21, wherein at least a portion of the second particles act to slow a growth rate of a hardened neutron population during a reaction transient event.

27. The nuclear fuel pellet of claim 21, wherein the nuclear adjuvant material has a coefficient of thermal expansion that is 50% to 150% of a coefficient of thermal expansion of the fissile material.

28. The nuclear fuel pellet of claim 21, further comprising a consumable absorber.

29. The nuclear fuel pellet of claim 21, wherein the second particles are at least one order of magnitude smaller than the first particles.

30. The nuclear fuel pellet of claim 29, wherein the second particles are at least three orders of magnitude smaller than the first particles.

31. The nuclear fuel pellet of claim 21, wherein the second particles are at least one order of magnitude larger than the first particles.

32. The nuclear fuel pellet of claim 21, wherein the second particles are at least three orders of magnitude larger than the first particles.

33. A nuclear fuel rod, comprising:
cladding; and
a plurality of nuclear fuel pellets supported by the cladding, wherein a first nuclear fuel pellet of the plurality comprises:
first particles formed of a fissile material; and
second particles formed of a nuclear adjuvant material.

34. The nuclear fuel rod of claim 33, wherein:
the nuclear adjuvant material comprises one or more atomic species able to absorb a portion of hardened neutrons generated within a nuclear reactor,
the hardened neutrons have energies greater than 800 keV and less than 20 MeV, and
the portion comprises between 0.00001% and 0.0001% of the hardened neutrons generated within the nuclear reactor.

35. The nuclear fuel rod of claim 34, wherein the one or more atomic species undergo a nuclear reaction upon absorption of hardened neutrons, and a product of the nuclear reaction comprises less than 1% neutrons.

36. The nuclear fuel rod of claim 34, wherein the one or more atomic species are selected from: Ba, As, Br, Ce, Cl, Co, F, Ga, Ge, K, La, Mo, Nd, Os, Pr, S, Sr, Ti, Tl, V, Zr, and combinations thereof.

37. The nuclear fuel rod of claim 34, wherein the one or more atomic species comprise one or more isotopes selected from: Ag¹⁰⁷, Ag¹⁰⁹, Ag¹¹¹, Ag¹¹³, Ag¹¹⁴, Ag¹¹⁵, Ag¹¹⁶, Ag¹¹⁷, B¹¹, C¹⁴, Ca⁴¹, Cd¹⁰⁷, Cd¹⁰⁸, Cd¹¹⁰, Cd¹¹¹, Cd¹¹², Cd¹¹³, Cd¹¹⁴, Cd¹¹⁵, Cd¹¹⁶, Ce¹³⁶, Ce¹³⁸, Ce¹³⁹, Ce¹⁴⁰, Ce¹⁴¹, Ce¹⁴², Ce¹⁴³, Ce¹⁴⁴, Cl³⁵, Cl³⁶, Cl³⁷, Cm²⁴⁵, Co⁵⁵, Co⁵⁸, Co⁵⁹, Cr⁴⁸, Cr⁵⁰, Cs¹³³, Cs¹³⁴, Cs¹³⁸, Cs¹³⁶, Cs¹³⁷, Cu⁶⁴, Dy¹⁵⁶, Dy¹⁵⁸ Dy¹⁶⁰, Dy¹⁶¹, Dy¹⁶², Dy¹⁶³, Dy¹⁶⁴, Dy¹⁶⁶, Er¹⁶², Er¹⁶⁴, Er¹⁶⁶, Er¹⁶⁷, Er¹⁶⁸, Er¹⁶⁹, Er¹⁷⁰, Eu¹⁵¹, Eu¹⁵², Eu¹⁵³, Eu¹⁵⁵, Eu¹⁵⁶, Eu¹⁵⁷, F¹⁹, Fe⁵², Fe⁵³, Fe⁵⁴, Fe⁵⁵, Ga⁶⁹, Ga⁷⁰, Ga⁷¹, Gd¹⁵², Gd¹⁵³, Gd¹⁵⁴, Gd¹⁵⁵, Gd¹⁵⁶, Gd¹⁵⁷, Gd¹⁵⁸, Gd¹⁵⁹, Gd¹⁶⁰, Ge⁶⁸, Ge⁶⁹, Ge⁷⁰, Ge⁷¹, Ge⁷², Ge⁷³, Ge⁷⁴, Ge⁷⁵, Ge⁷⁶, Ge⁷⁷, Ge⁷⁸, Hf¹⁷⁴, Hf¹⁷⁶, Hf¹⁷⁷, Hf¹⁷⁸, Hf¹⁷⁹, Hf¹⁸⁰, Hg¹⁹⁷, Ho¹⁶⁵, In¹¹³, In¹¹⁴, In¹¹⁵, Ir¹⁹¹, Ir¹⁹³, K⁴¹, K⁴³, La¹³⁸, Li⁶, Lu¹⁷⁵, Lu¹⁷⁶, Mg²⁴, Mg²⁵, Mg²⁶, Mg²⁸, Mn⁵⁵, Mo⁹², Mo⁹⁴, Mo⁹⁵, Mo⁹⁶, Mo⁹⁷, Mo⁹⁸, Mo⁹⁹, Mo¹⁰⁰, N¹⁴, N¹⁵, Na²², Na²³, Na²⁴, Nb⁹⁰, Nb⁹⁴, Nb⁹⁵, Nb⁹⁶, Nd¹⁴², Nd¹⁴³, Nd¹⁴⁴, Nd¹⁴⁵, Nd¹⁴⁶, Nd¹⁴⁷, Nd¹⁴⁸, Nd¹⁴⁹, Nd¹⁵⁰, Ni⁵⁸, Ni⁵⁹, Ni⁶⁰, Ni⁶¹, Ni⁶², Ni⁶³, Ni⁶⁴, Np²³⁶, O¹⁷, O¹⁸, Os¹⁸⁵, Os¹⁸⁶, Os¹⁸⁸, Os¹⁸⁹, Os¹⁹⁰, Os¹⁹², Os¹⁹⁴, Pa²³¹, Pa²³³, Pb²⁰⁹, Pb²¹⁰, Pd¹⁰⁰, Pd¹⁰¹, Pd¹⁰², Pd¹⁰³, Pd¹⁰⁴, Pd¹⁰⁵, Pd¹⁰⁶, Pd¹⁰⁷, Pd¹⁰⁸, Pd¹⁰⁹, Pd¹¹⁰, Pd¹¹², Pm¹⁴⁷, Pm¹⁴⁸, Pm¹⁴⁹, Pm¹⁵⁰, Pm¹⁵¹, Pr¹⁴¹, Pr¹⁴², Pr¹⁴³, Pu²³⁶, Pu²³⁷, Pu²³⁸, Pu²⁴⁰, Pu²⁴², Pu²⁴³, Pu²⁴⁵, Rb⁸³, Rb⁸⁴, Rb⁸⁵, Rb⁸⁶, Rb⁸⁷, Re¹⁸², Re¹⁸³, Re¹⁸⁴, Re¹⁸⁵, Re¹⁸⁷, Rh¹⁰³, Rh¹⁰⁴, Rh¹⁰⁵, Ru¹⁰⁰, Ru¹⁰¹, Ru¹⁰², Ru¹⁰³, Ru¹⁰⁴, Ru¹⁰⁵, Ru¹⁰⁶, Ru⁹⁶, Ru⁹⁸, Ru⁹⁹, S³², S³⁴, S³⁵, S³⁶, Sb¹²¹, Sb¹²², Sb¹²³, Sb¹²⁴, Sb¹²⁵, Sb¹²⁶, Sc⁴⁵, Se⁷², Se⁷³, Se⁷⁴, Se⁷⁶, Se⁷⁷, Se⁷⁸, Se⁷⁹, Se⁸⁰, Se⁸¹, Se⁸², Si²⁸, Si³¹, Si³², Sm¹⁴⁴, Sm¹⁴⁶, Sm¹⁴⁷, Sm¹⁴⁸, Sm¹⁴⁹, Sm¹⁵⁰, Sm¹⁵¹, Sm¹⁵², Sm¹⁵³, Sm¹⁵⁴, Sm¹⁵⁶, Sn¹¹², Sn¹¹³, Sn¹¹⁴, Sn¹¹⁵, Sn¹¹⁶, Sn¹¹⁷, Sn¹¹⁸, Sn¹¹⁹, Sn¹²⁰, Sn¹²², Sn¹²³, Sn¹²⁵, Sn¹²⁶, Sr⁸², Sr⁸⁴, Sr⁸⁵, Sr⁸⁶, Sr⁸⁷, Sr⁸⁸, Sr⁸⁹, Sr⁹⁰, Sr⁹¹, Ta¹⁸², Tb¹⁵⁹, Te¹¹⁸, Te¹¹⁹, Te¹²⁰, Te¹²², Te¹²³, Te¹²⁴, Te¹²⁵, Te¹²⁶, Te¹²⁷, Te¹²⁸, Te¹³¹, Te¹³², Th²³¹, Th²³², Ti⁴⁵, Ti⁴⁶, Ti⁴⁷, Ti⁴⁸, Ti⁴⁹, Ti⁵⁰, Ti⁵¹, Tm¹⁶⁸, Tm¹⁶⁹, Tm¹⁷², U²³⁴, U²³⁵, U²³⁶, U²³⁷, U²³⁹, V⁴⁹, V⁵¹, W¹⁷⁸, W¹⁸⁰, W¹⁸¹, W¹⁸⁴, W¹⁸⁶, W¹⁸⁷, Y⁸⁶, Y⁸⁹, Y⁹⁰, Y⁹¹, Yb¹⁶⁸, Yb¹⁷⁰, Yb¹⁷¹, Yb¹⁷², Yb¹⁷³, Yb¹⁷⁴, Yb¹⁷⁵, Zn⁶², Zn⁶⁵, Zn⁷⁰, Zn⁷², Zr⁹⁰, Zr⁹¹, Zr⁹², Zr⁹³, Zr⁹⁴, Zr⁹⁵, Zr⁹⁶, and combinations thereof.

38. The nuclear fuel rod of claim 33, wherein the first nuclear fuel pellet further comprises a consumable absorber.

39. The nuclear fuel rod of claim 33, wherein the second particles are at least one order of magnitude smaller than the first particles.

40. The nuclear fuel rod of claim 39, wherein the second particles are at least three orders of magnitude smaller than the first particles.

41. The nuclear fuel rod of claim 33, wherein the second particles are at least one order of magnitude larger than the first particles.

42. The nuclear fuel rod of claim 33, wherein the second particles are at least three orders of magnitude larger than the first particles.
